(19) United States
(12) Patent Application Publication
(10) Pub. No.: US 2020/0022384 A1
(43) Pub. Date: Jan. 23, 2020

(54) MINERAL SUPPLEMENTATION IN ALGAE

(71) Applicants: Martin Gross, Boone, IA (US); Zhiyou Wen, Ames, IA (US); Xuefei Zhao, Ames, IA (US)

(72) Inventors: Martin Gross, Boone, IA (US); Zhiyou Wen, Ames, IA (US); Xuefei Zhao, Ames, IA (US)

(21) Appl. No.: 16/515,659

(22) Filed: Jul. 18, 2019

Related U.S. Application Data
(60) Provisional application No. 62/701,914, filed on Jul. 23, 2018.

(51) Int. Cl. A23K 10/16; A23L 33/16; C12R 1/89; C01B 19/00; A01G 33/00; C01B 19/02

(52) U.S. Cl. CPC A23K 10/16; A23L 33/16; C12R 1/89; C01B 19/008; A01G 33/00; C01B 19/02; C01B 19/007

(57) ABSTRACT

A method of producing mineral-rich algae by growing algae with an algae biofilm growing apparatus, wherein the algae is fed a mineral-rich feed stock. Furthermore, the mineral-rich algae is harvested and used as a foodstuff for human and animal consumption.

### CROSS REFERENCE TO RELATED APPLICATIONS

This patent application claims priority to U.S. Provisional Patent Application Ser. No. 62/701,914 filed on Jul. 23, 2018, which is fully incorporated by reference herein.

### FIELD OF THE DISCLOSURE

This disclosure relates generally to a method of producing mineral-rich algae by growing algae utilizing an algae biofilm growing apparatus and feeding the algae a mineral-rich feed stock. In one arrangement, the disclosure relates to a method of producing selenium-rich algae by producing algae utilizing an algae biofilm growing apparatus and feeding the algae a selenium-rich feed stock. In another arrangement, the disclosure relates to a method of producing mineral-rich algae by growing algae, harvesting the algae, adding a mineral-rich fluid to the algae to produce an algae slurry, and allowing the algae to consume the mineral(s) contained within the fluid. Additionally, the disclosure relates to a method of harvesting the mineral-rich algae and using the mineral-rich algae as a foodstuff for human and animal consumption.

### BACKGROUND OF THE DISCLOSURE

This disclosure relates to a unique algal biofilm-based cultivation process to produce mineral-rich algae which can be used as a food/feed supplement. In one arrangement, as one example, the disclosure relates to a unique algal based cultivation process to produce selenium-rich algae which can be used as a food/feed supplement for humans and animals. Selenium is an essential element in the human diet due to its various effects on human health. Selenium also plays an important role in maintaining animal health. The deficiency of selenium in food is known to cause various human diseases such as Keshan disease. Selenium deficiency in animal feed can cause white muscle disease or even death. The disclosed system provides a method for obtaining a selenium-rich algae that provides a sustainable selenium supply for human food and animal feed. Despite the numerous health benefits of selenium, the current sources for selenium supplementation in human and animal diets are either not effective (i.e., selenium is not in a bioavailable form) or is very costly to produce. Thus, there is a need for new methods for producing bioavailable selenium production pathways to be developed.

Furthermore, minerals, such as selenium, and other nutrients being present in manufacturing effluent is problematic for manufacturers. For example, a feed manufacturing plant will produce large volumes of selenium-rich processing effluent or wastewater. The manufacturers must pay large fines to their local municipality as a result of their effluent or wastewater containing large volumes of mineral or nutrient rich effluent, such as selenium-rich effluent. Therefore, there is a need for a process that can quickly, efficiently and costly remove selenium and other minerals or nutrients from fluid and/or effluent.

For the reasons stated above, and for other reasons stated below which will become apparent to those skilled in the art upon reading and understanding the specification, there is a need in the art for an improved method of producing mineral-rich algae.

Thus it is a primary object of the disclosure to provide a method of producing mineral-rich algae that is bioavailable.

Another object of the disclosure is to provide a method of producing mineral-rich algae that is efficient.

Yet another object of the disclosure is to provide a method of producing mineral-rich algae that is simple in design.

Another object of the disclosure is to provide a method of producing mineral-rich algae that is inexpensive.

Yet another object of the disclosure is to provide a method of producing mineral-rich algae that may be utilized as a foodstuff for human consumption.

Another object of the disclosure is to provide a method of producing mineral-rich algae that may be utilized as a foodstuff for animal consumption.

Yet another object of the disclosure is to provide a method of producing mineral-rich algae that optimizes mineral accumulation in algae.

Another object of the disclosure is to provide a method of producing mineral-rich algae that efficiently and effectively removes minerals from fluid.

Yet another object of the disclosure is to provide a method of producing mineral-rich algae that efficiently and effectively removes minerals from effluent.

Another object of the disclosure is to provide a method of producing mineral-rich algae that provides for the algae to absorb inorganic minerals and produce a bio-available mineral.

These and other objects, features, or advantages of the present disclosure will become apparent from the specification and claims.

### BRIEF SUMMARY OF THE DISCLOSURE

The disclosure relates to a method of producing mineral-rich algae by growing algae utilizing an algae biofilm growing apparatus and feeding the algae a mineral-rich feedstock. Furthermore, the disclosure relates to a method of producing a selenium-rich algae by growing algae utilizing an algae biofilm growing apparatus and feeding the algae a selenium-rich feedstock. The disclosure also relates to a method of producing mineral-rich algae by growing algae, harvesting the algae, adding a mineral-rich fluid to the algae to produce an algae slurry, and allowing the algae to consume the mineral(s) contained within the fluid. Additionally, the disclosure relates to a method of harvesting the mineral-rich algae and using the mineral-rich algae as a foodstuff for human and animal consumption.

### BRIEF DESCRIPTION OF THE DRAWINGS

FIG. 1 depicts a flow chart illustrating the methodology generally associated with algae harvesting;

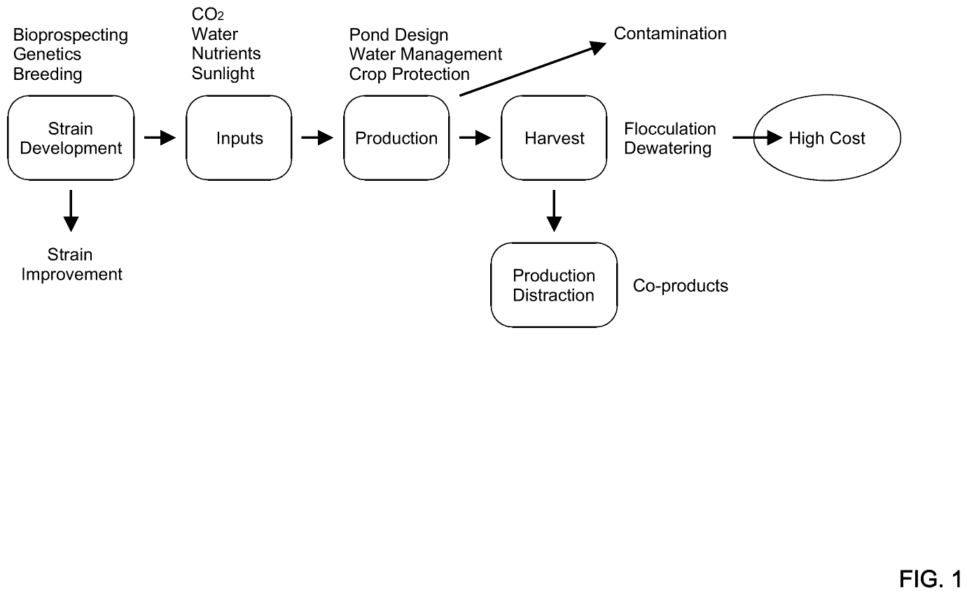

FIG. 2 depicts a top view of algae being grown on a moving belt;

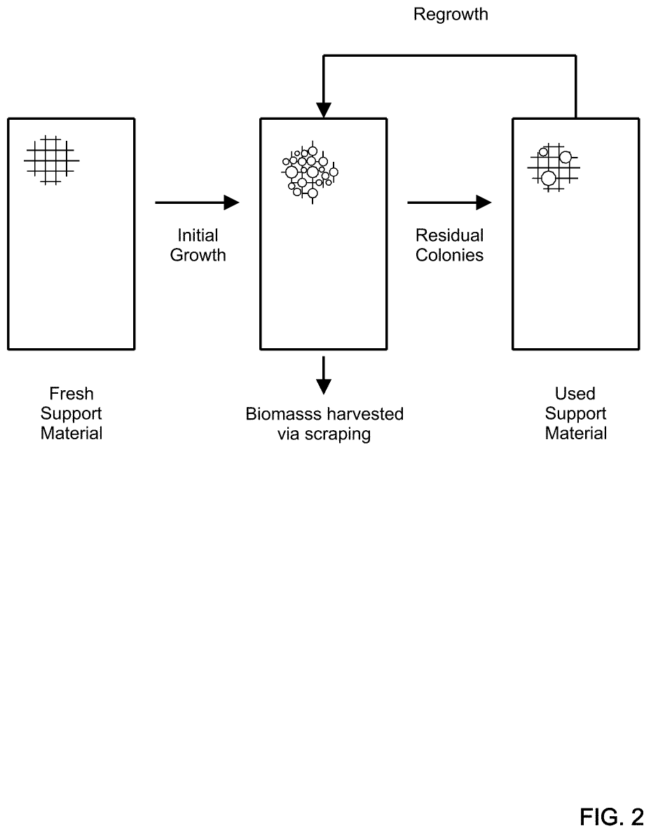

FIG. 3 depicts a partial cutaway perspective view of an algae biofilm growing apparatus according to one embodiment;

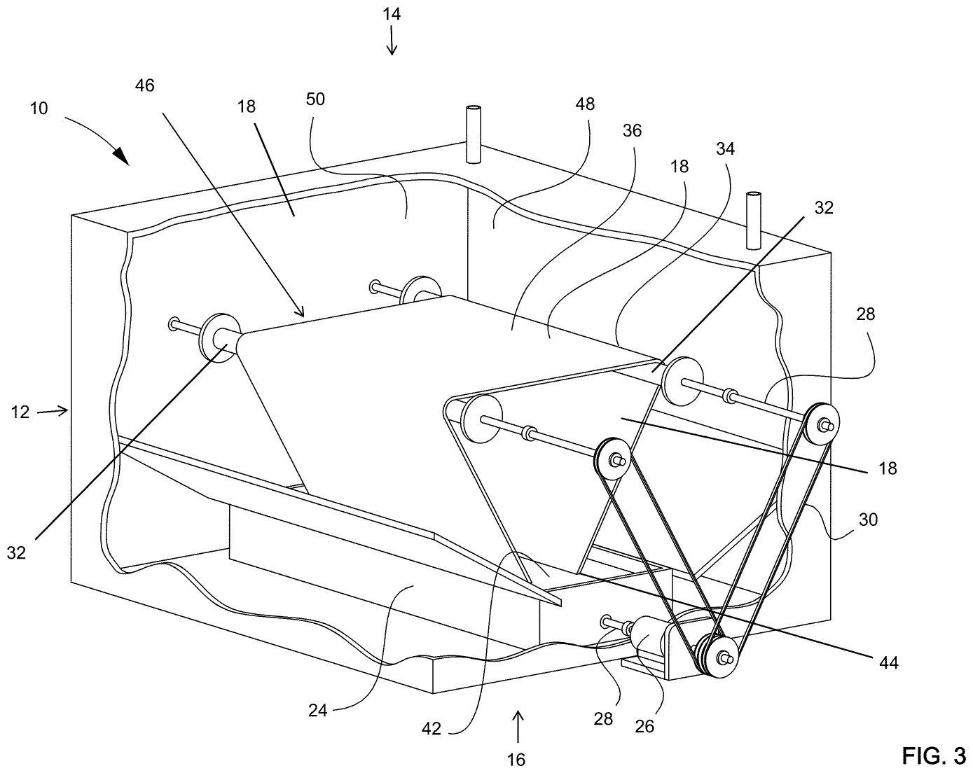

FIG. 4 depicts a schematic front view of the algae biofilm growing apparatus illustrated in FIG. 3;

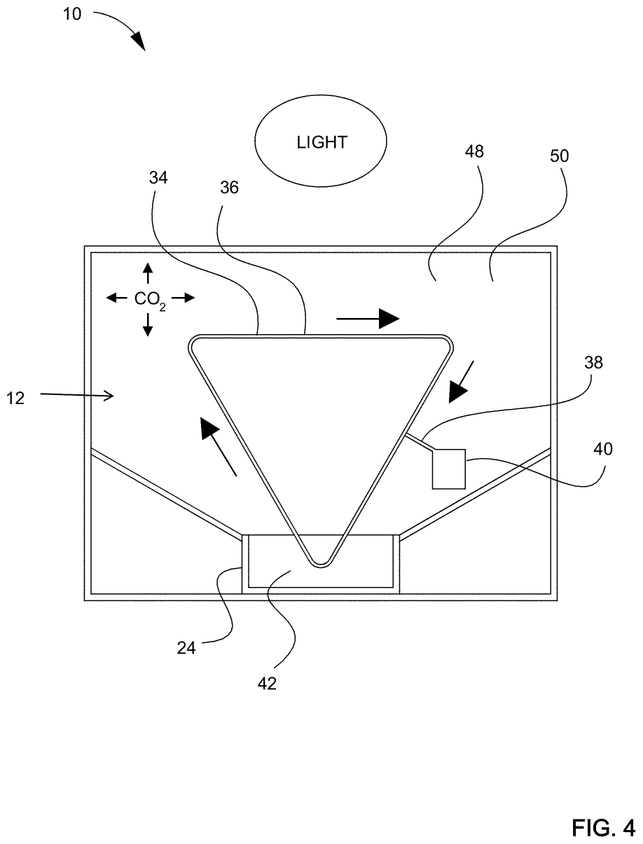

FIG. 5 depicts a top view of algae being grown on a variety of materials which are used to form the at least one moving belt;

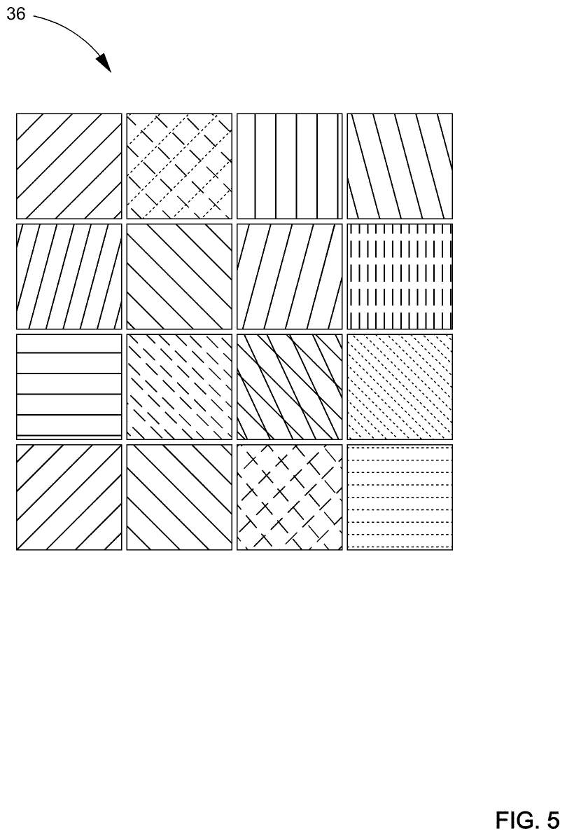

FIG. 6 depicts a bar chart of harvesting frequencies for an algal strain according to one embodiment;

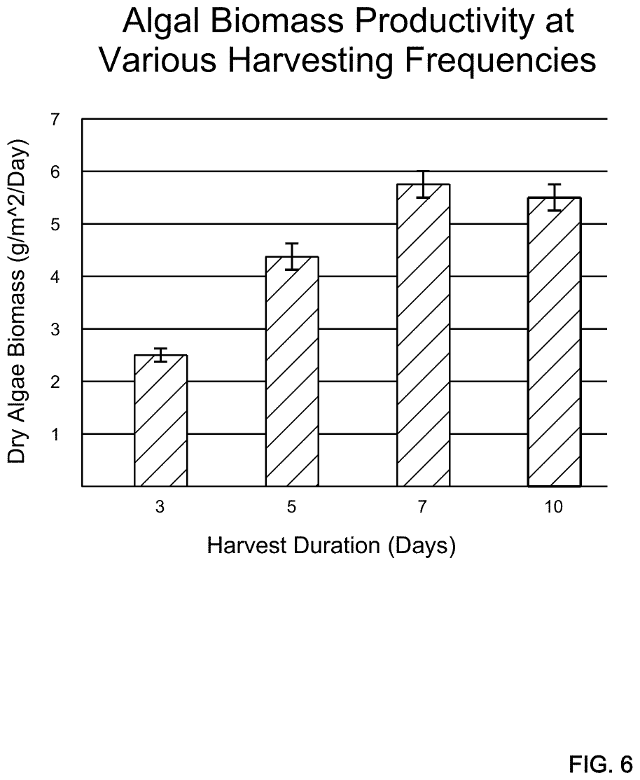

FIG. 7 depicts a partial cutaway perspective view of the algae biofilm growing apparatus illustrated in FIG. 3, shown with grow lights and gas input;

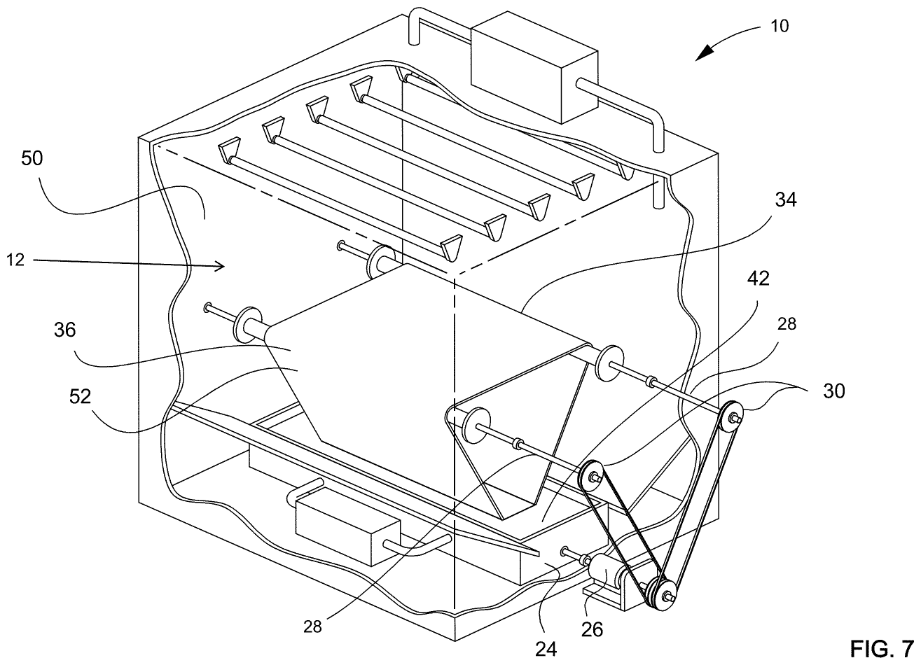

FIG. 8 depicts a partial exploded view of the algae biofilm growing apparatus shown in FIG. 3;

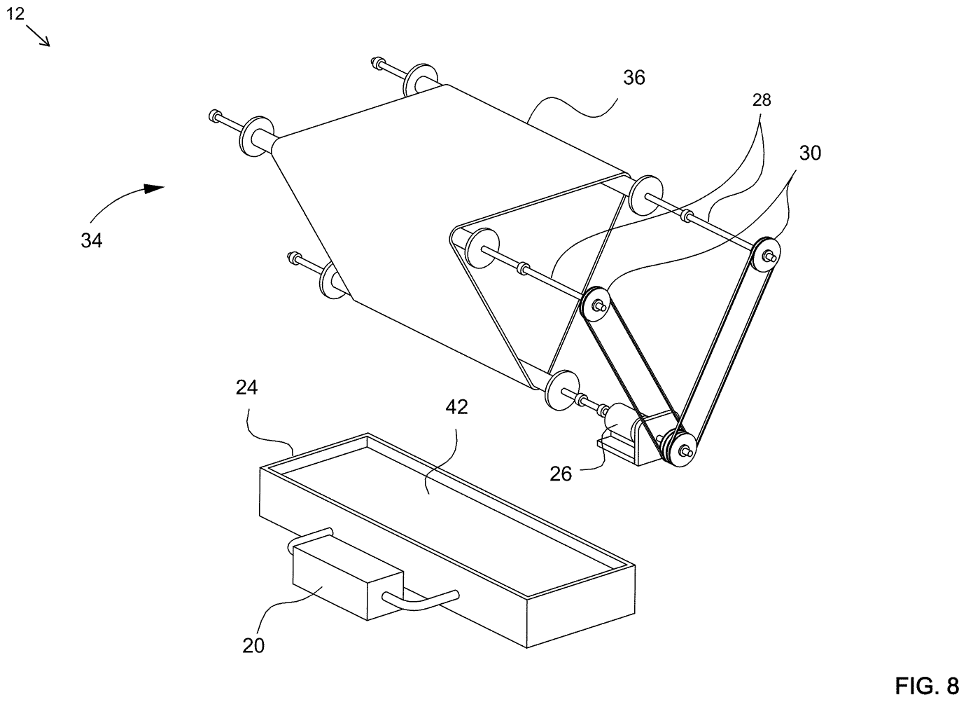

FIG. 9 depicts a perspective view of a system having a plurality of associated algae biofilm growing apparatuses and a trough system according to one embodiment;

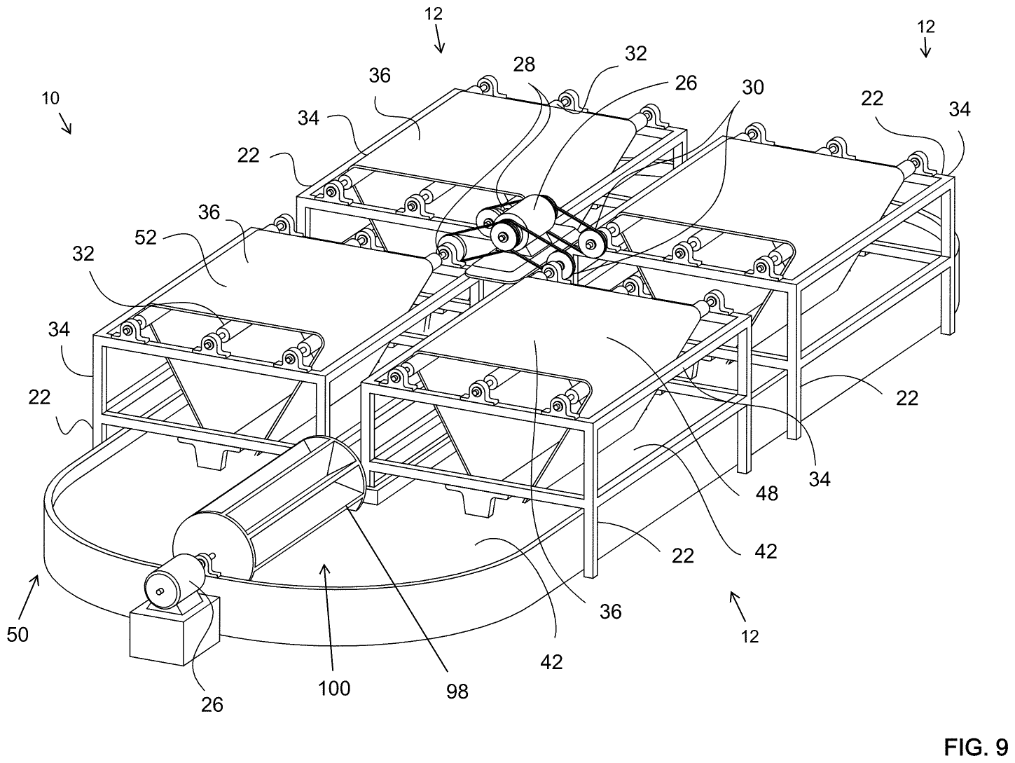

FIG. 10 depicts a perspective view of an algae biofilm growing apparatus as illustrated in FIG. 12;

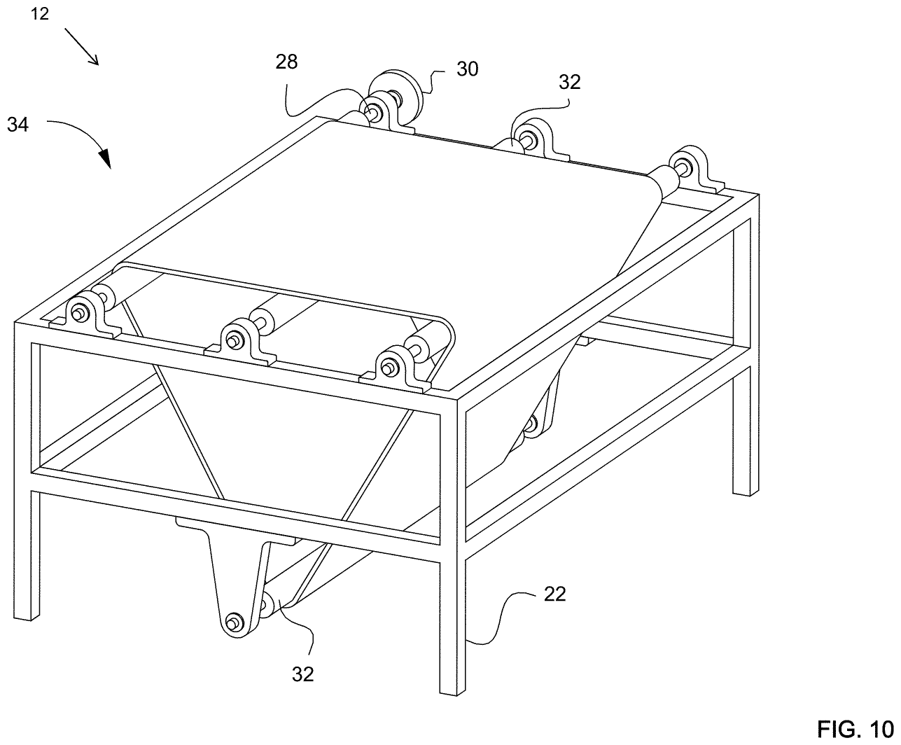

FIG. 11 depicts a perspective view of a trough system illustrated in FIG. 12;

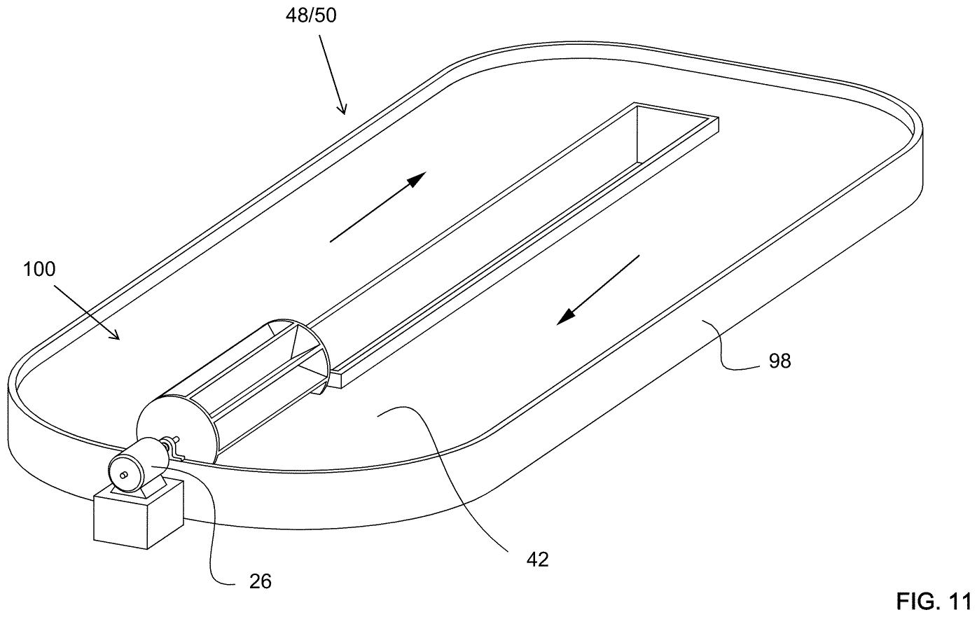

FIG. 12 depicts a perspective view of a system having a plurality of associated algae biofilm growing apparatuses and a trough system according to an alternate embodiment;

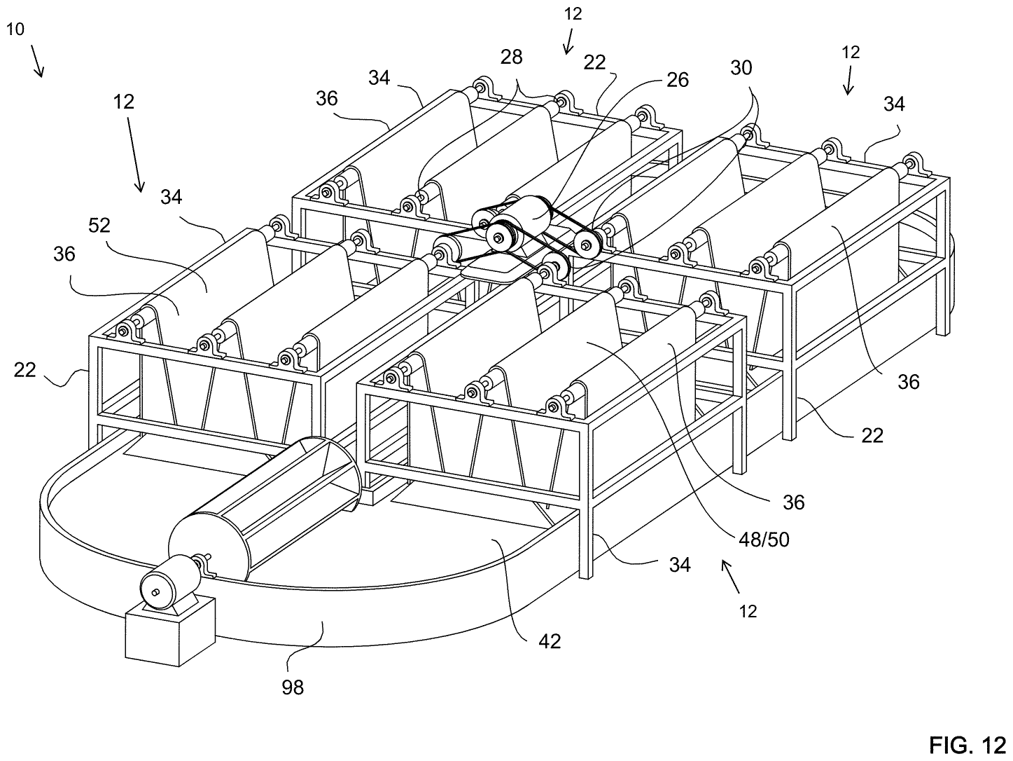

FIG. 13 depicts a perspective view of an algae biofilm growing apparatus as illustrated in FIG. 12;

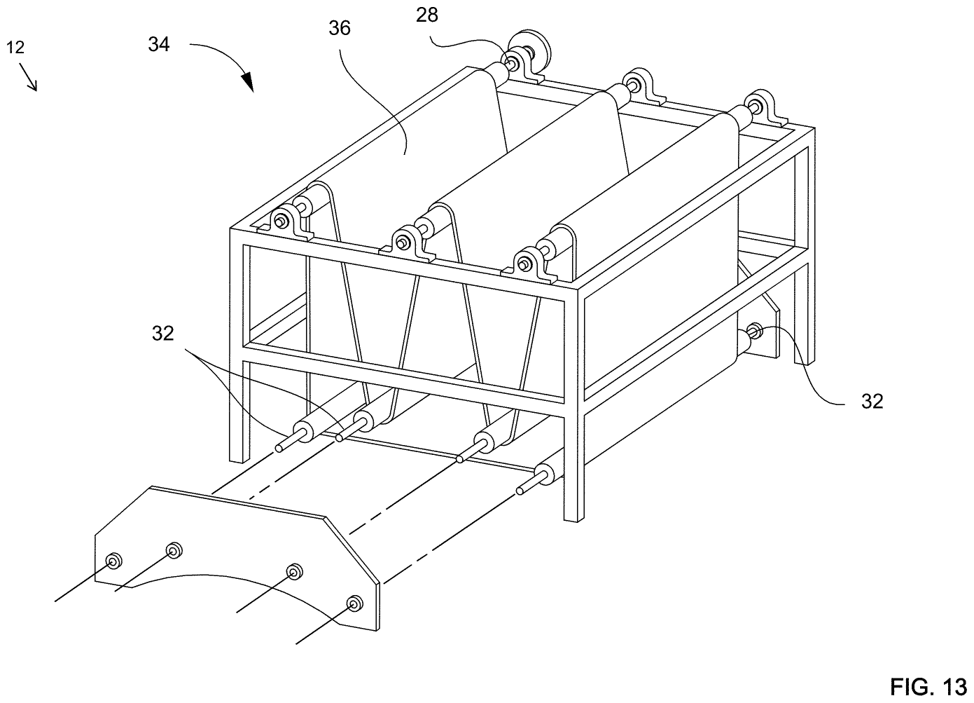

FIG. 14 depicts a perspective view of a system having associated algae biofilm growing apparatuses and a trough system according to one embodiment;

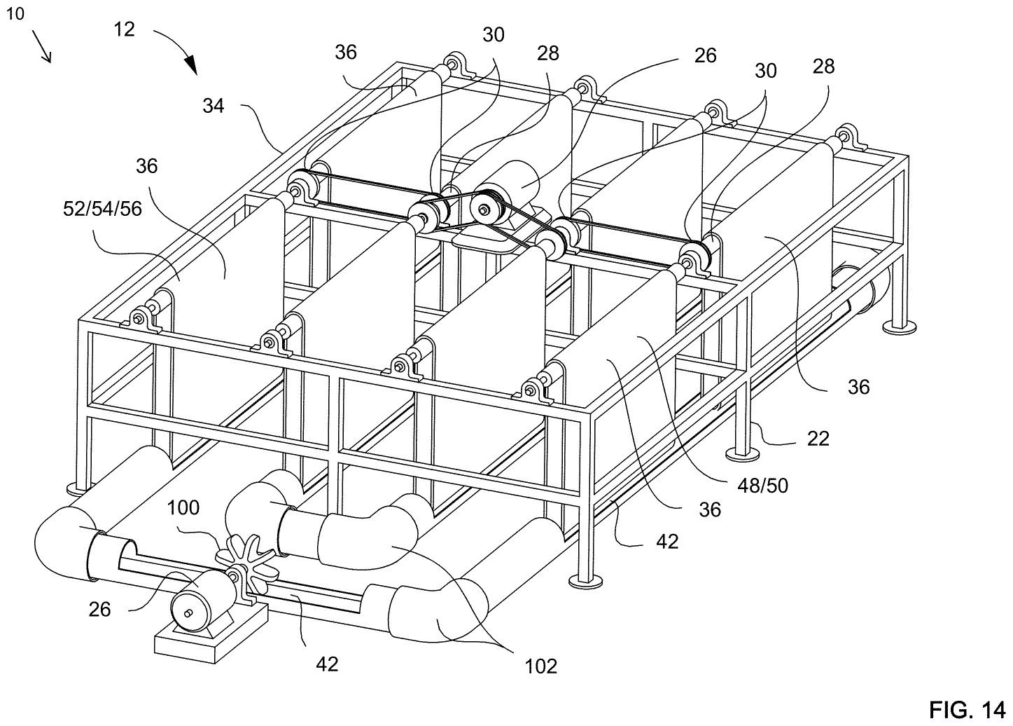

FIG. 15 depicts a perspective view of the system having associated algae biofilm growing apparatuses as illustrated in FIG. 14;

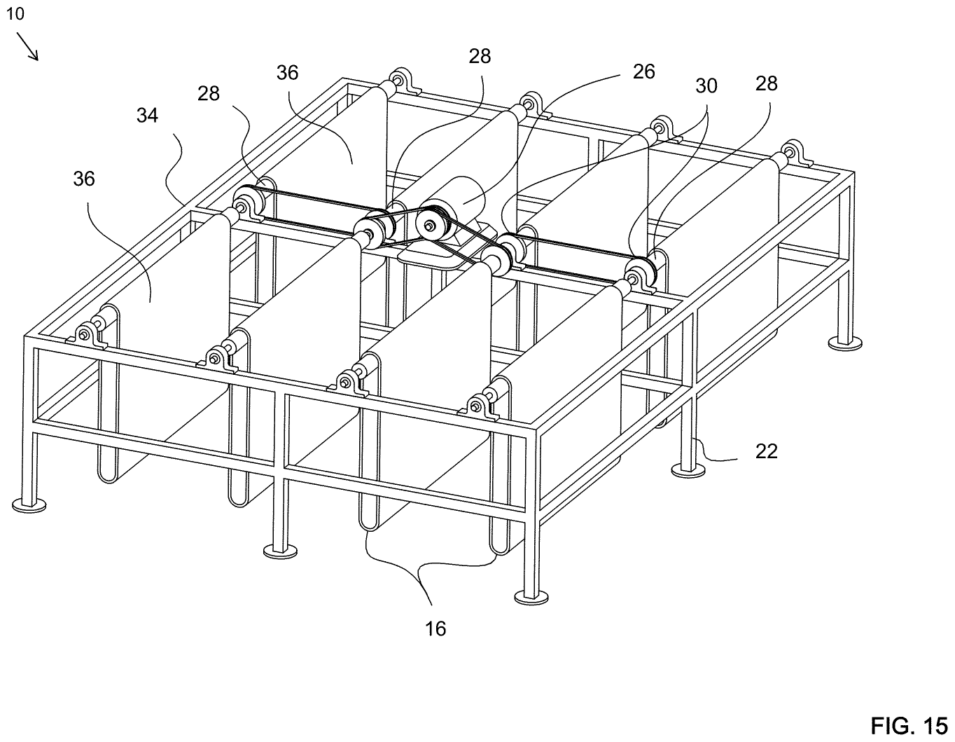

FIG. 16 depicts a perspective view of the trough system illustrated in FIG. 14;

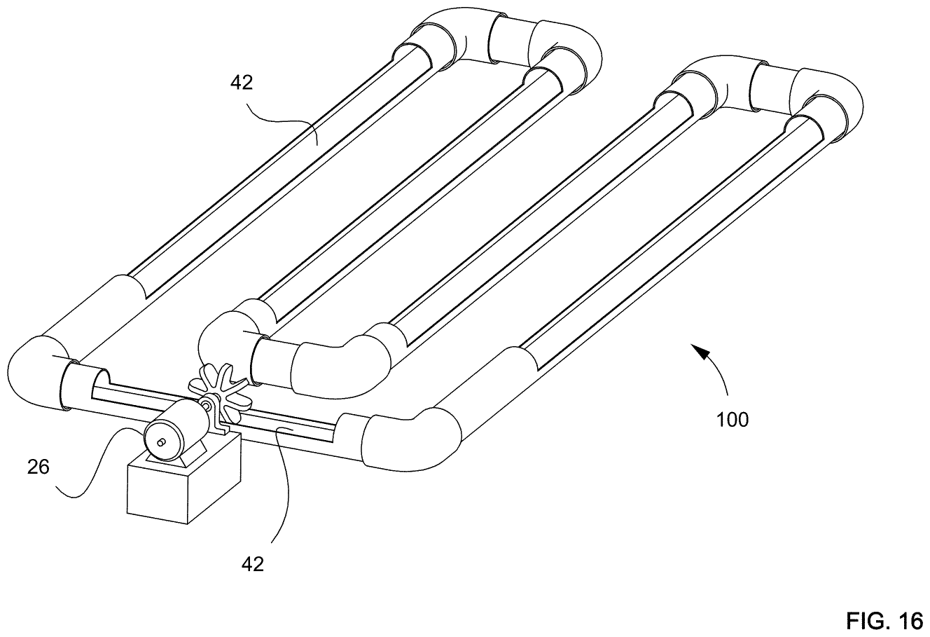

FIG. 17 depicts a perspective view of an algae biofilm growing apparatus shown with a mechanized harvesting system according to one embodiment;

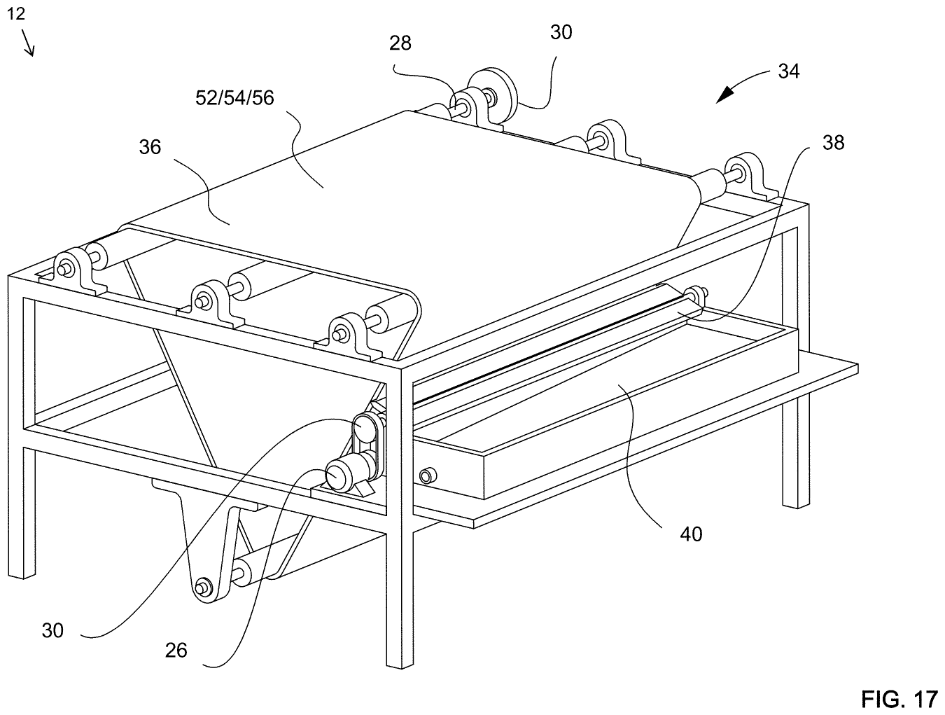

FIG. 18 depicts a perspective view of an algae biofilm growing apparatus according to one embodiment;

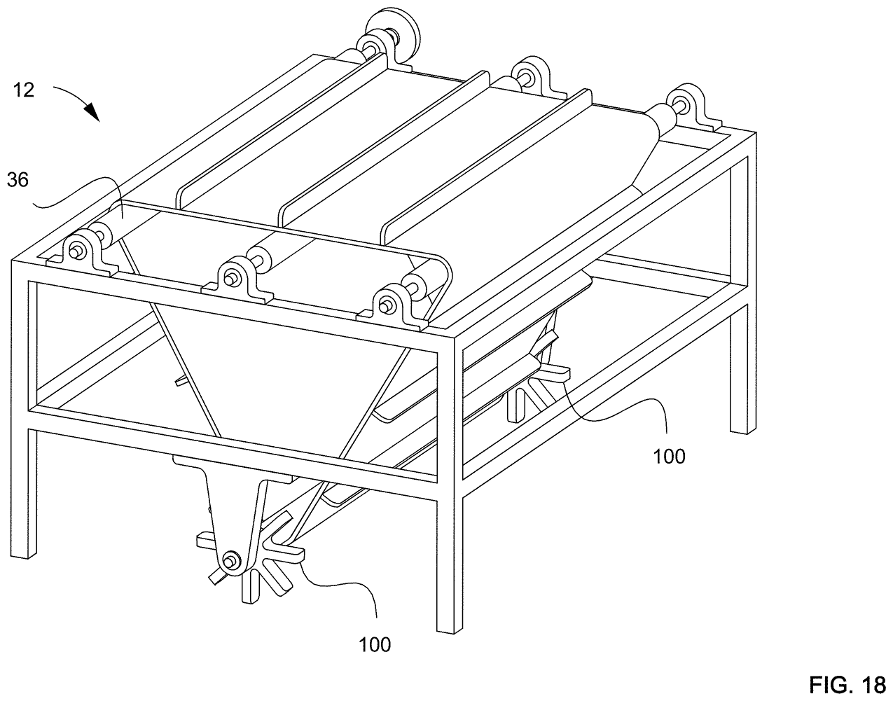

FIG. 19 depicts a perspective view of a system according to one embodiment;

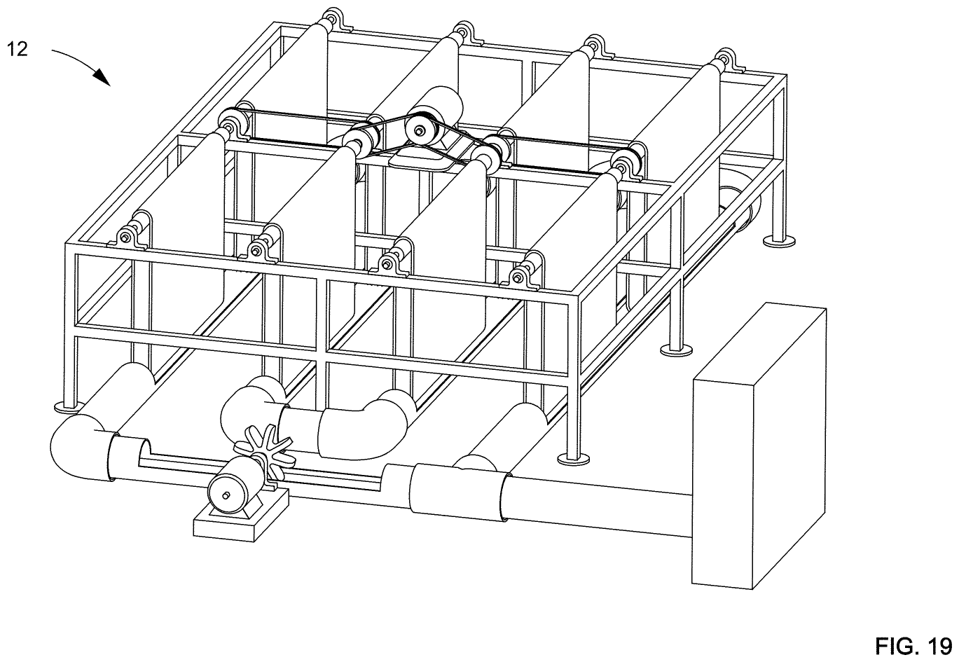

FIG. 20 depicts a perspective view of an algae biofilm growing apparatus according to one embodiment;

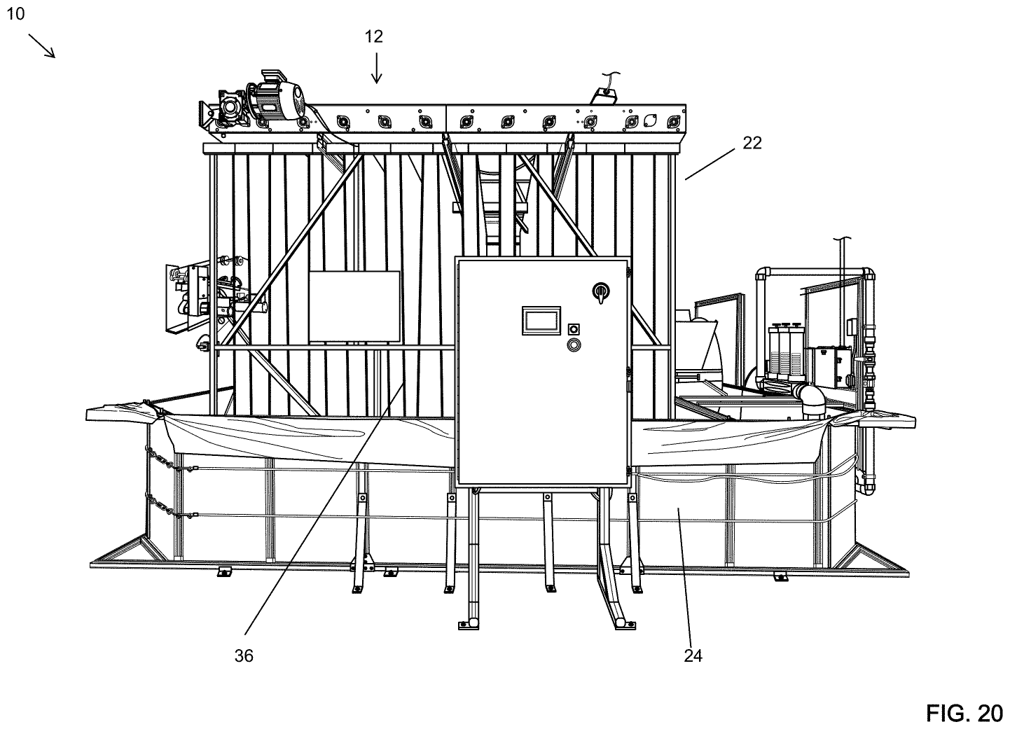

FIG. 21 depicts a perspective view of an algae biofilm growing apparatus according to one embodiment;

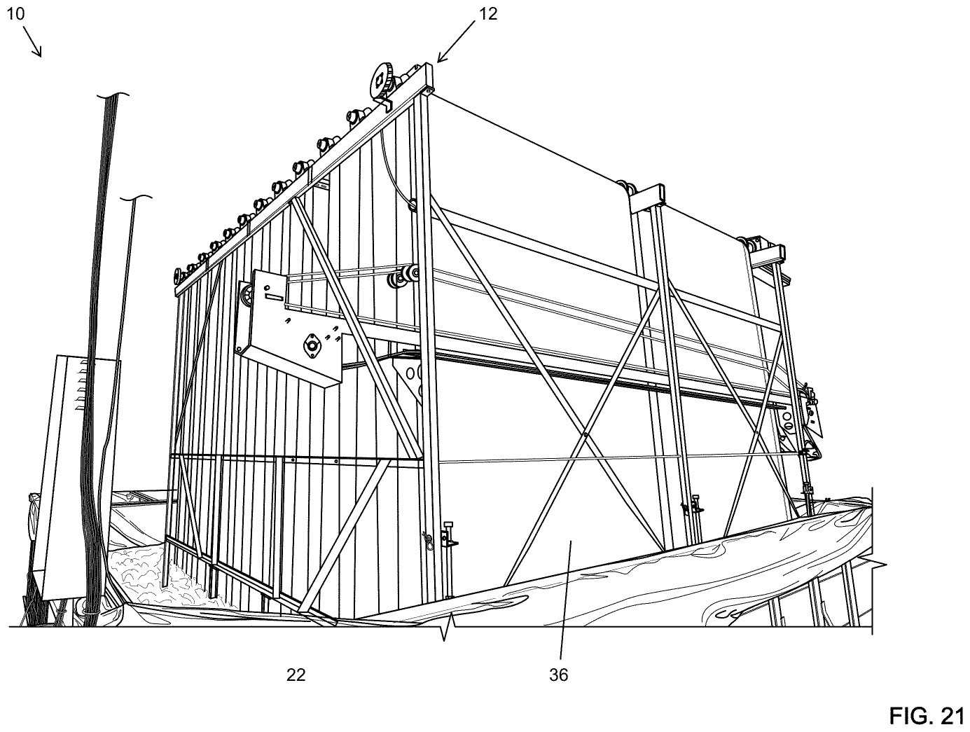

FIG. 22 depicts a perspective view of a trough system according to one embodiment;

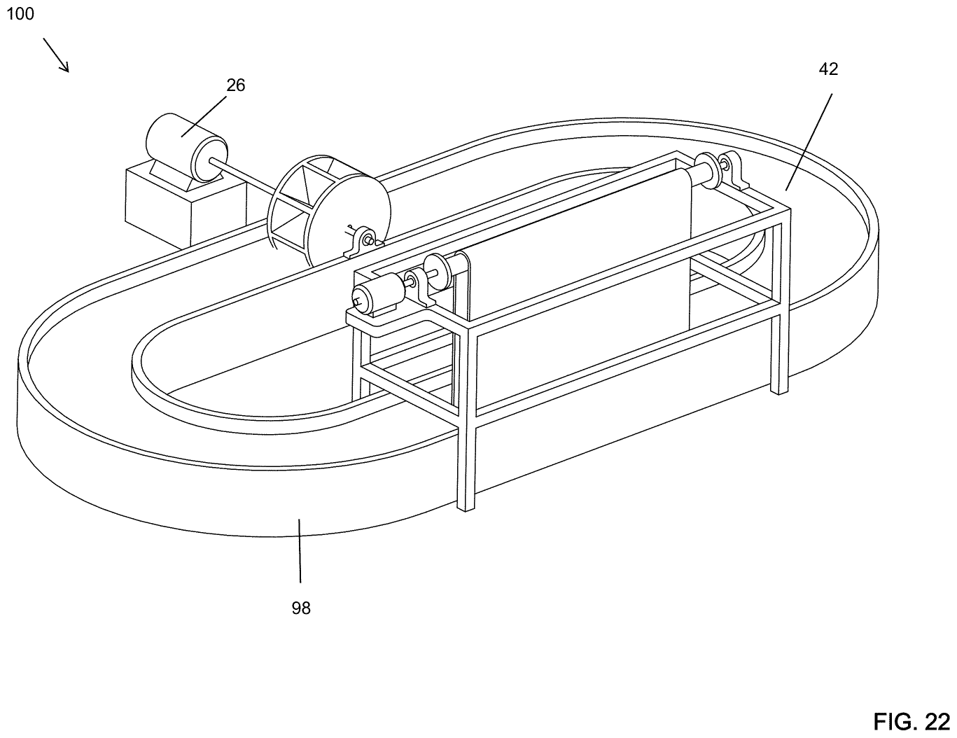

FIG. 23 depicts a flow chart illustrating a method associated with growing algae using an algae biofilm growing apparatus wherein the algae is fed a selenium-rich feedstock in order to produce a selenium-rich algae;

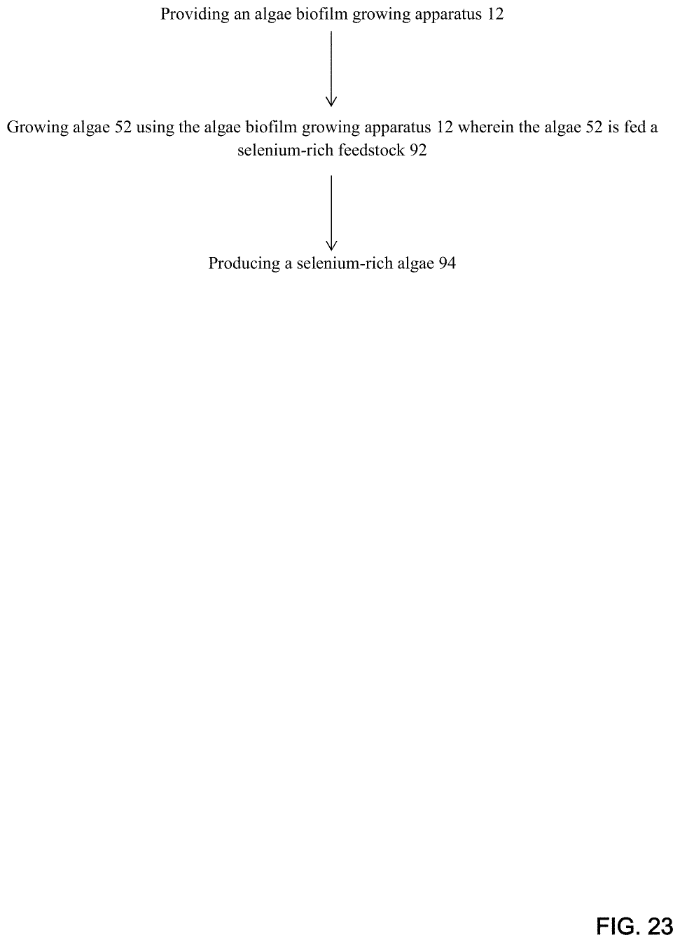

FIG. 24 depicts a flow chart illustrating a method associated with growing algae using an algae biofilm growing apparatus wherein the algae is fed a selenium-rich feedstock in order to produce a selenium-rich algae; wherein the selenium-rich feedstock is an inorganic selenium;

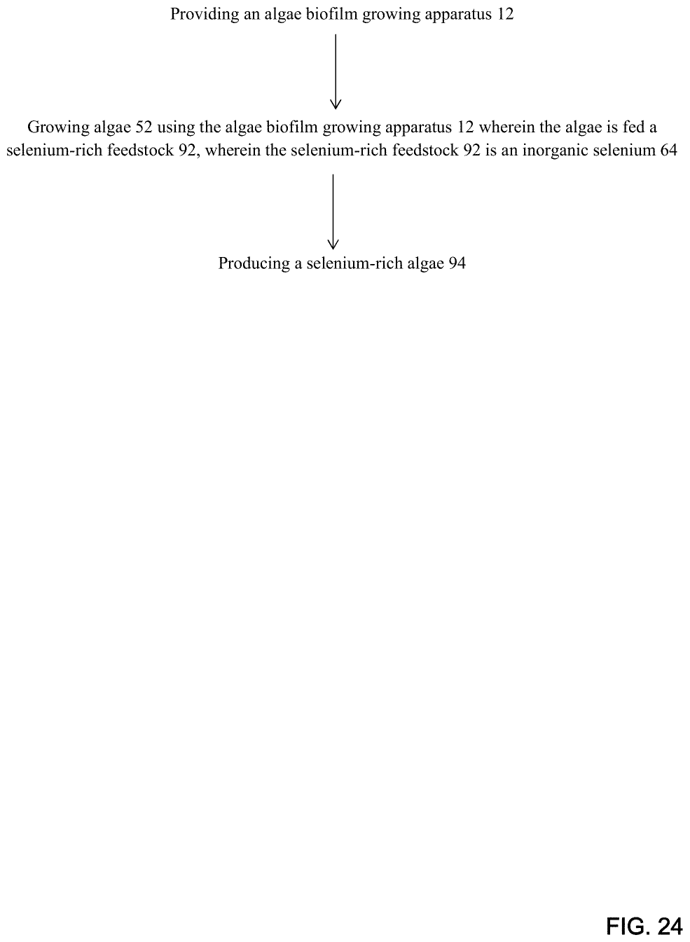

FIG. 25 depicts a flow chart illustrating a method associated with growing algae using an algae biofilm growing apparatus wherein the algae is fed a selenium-rich feedstock in order to produce a selenium-rich algae; wherein the selenium-rich feedstock includes a selenium salt;

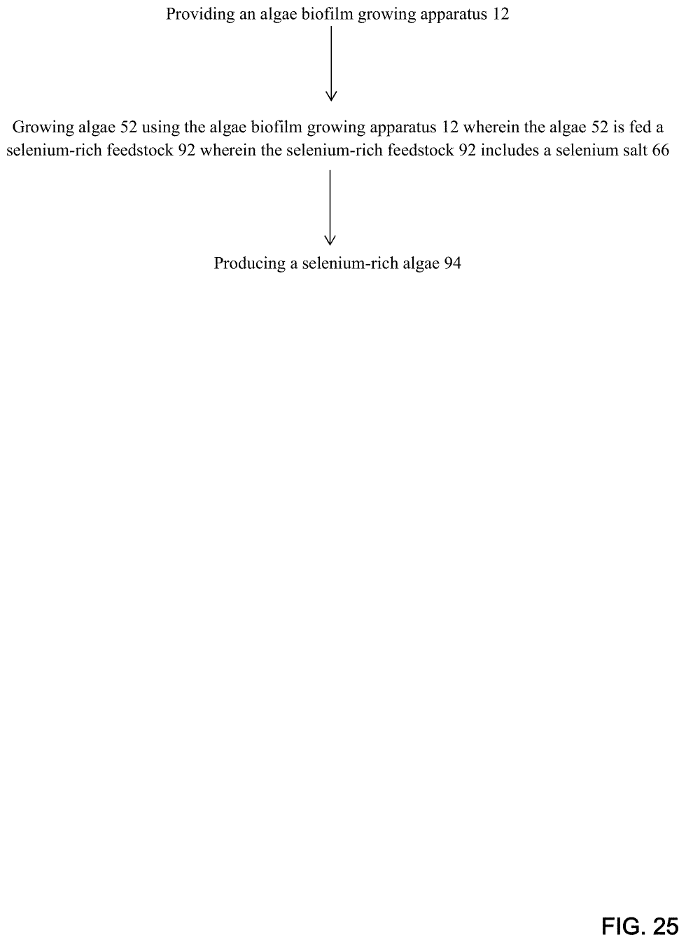

FIG. 26 depicts a flow chart illustrating a method associated with growing algae using an algae biofilm growing apparatus wherein the algae is fed a selenium-rich feedstock in order to produce a selenium-rich algae; wherein the selenium-rich feedstock includes sodium selenite;

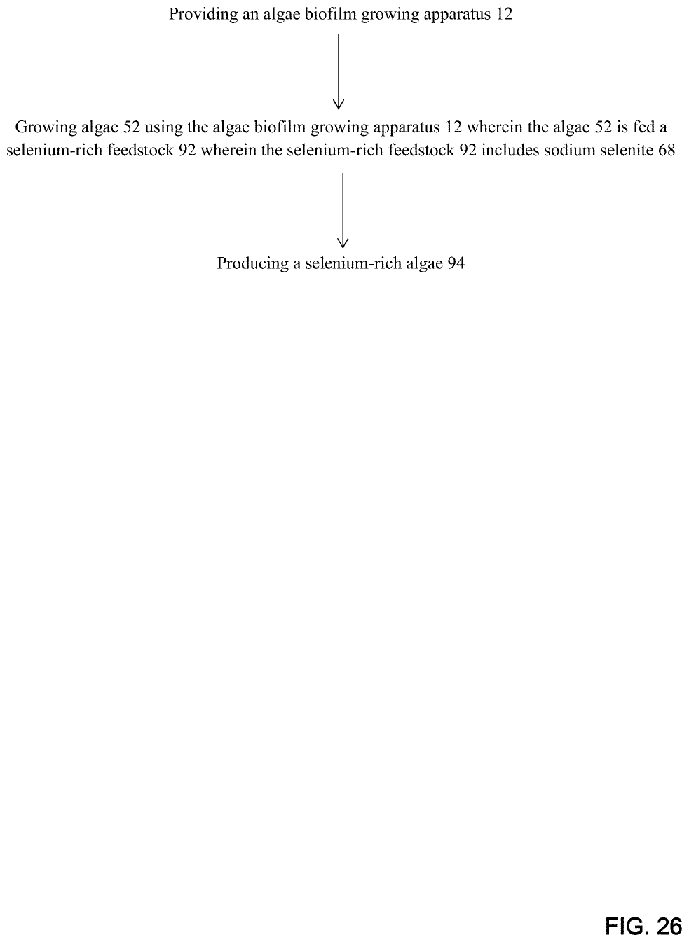

FIG. 27 depicts a flow chart illustrating a method associated with growing algae using an algae biofilm growing apparatus wherein the algae is fed a selenium-rich feedstock in order to produce a selenium-rich algae; wherein the selenium-rich feedstock includes sodium selenite;

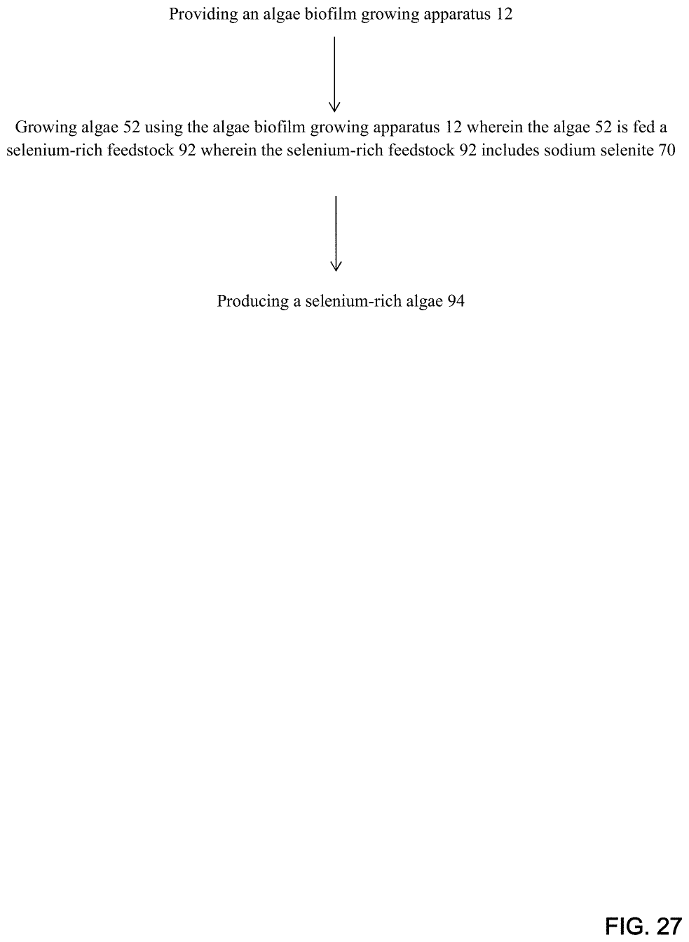

FIG. 28 depicts a flow chart illustrating a method associated with growing algae using an algae biofilm growing apparatus wherein the algae is fed an inorganic selenium-rich feedstock; wherein the algae absorbs the inorganic selenium-rich feedstock thereby producing a bio-available selenium and a selenium-rich algae;

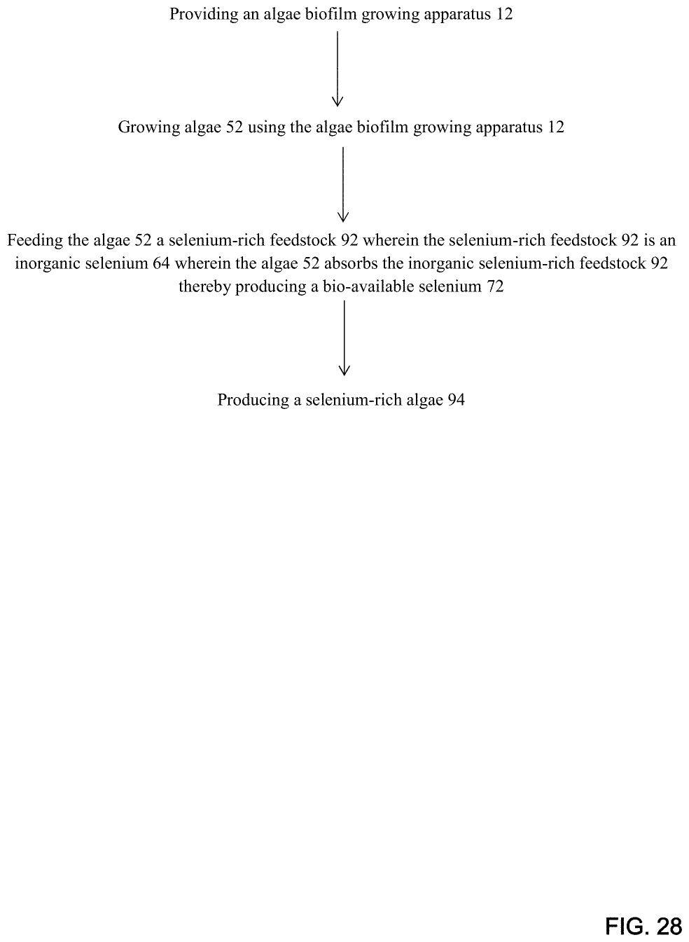

FIG. 29 depicts a flow chart illustrating a method associated with growing algae using an algae biofilm growing apparatus wherein the algae is fed a selenium-rich feedstock wherein the algae contains extracellular polymeric substances which enhance adsorption of selenium by the algae in order to produce a selenium-rich algae;

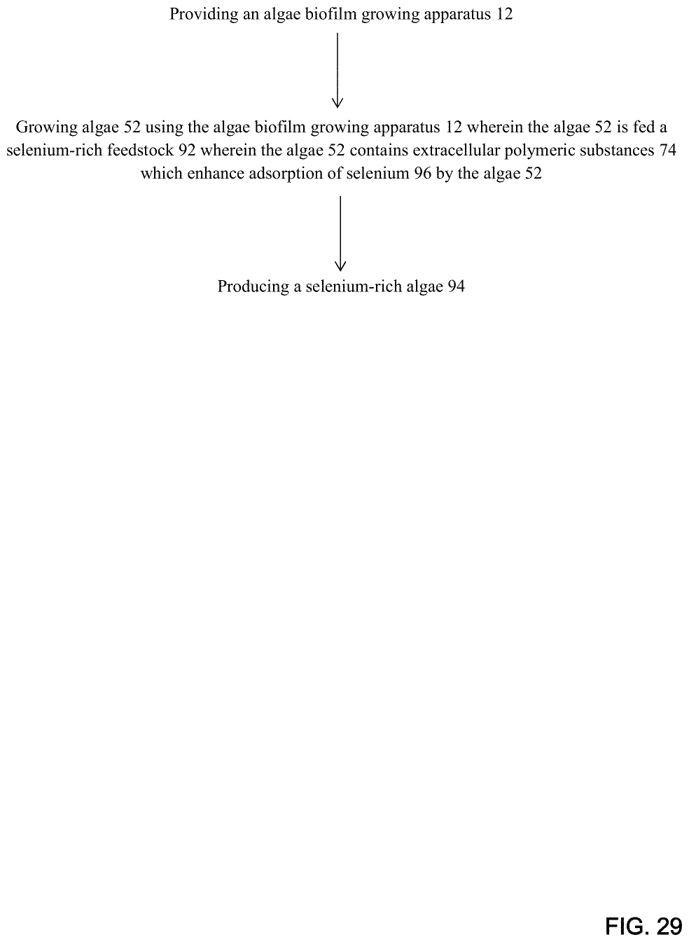

FIG. 30 depicts a flow chart illustrating a method associated with growing algae using an algae biofilm growing apparatus wherein the algae is fed a selenium-rich feedstock; wherein the algae biofilm growing apparatus is exposed to air wherein the temperature of the air within the algae biofilm apparatus is controlled; wherein a selenium-rich algae is produced;

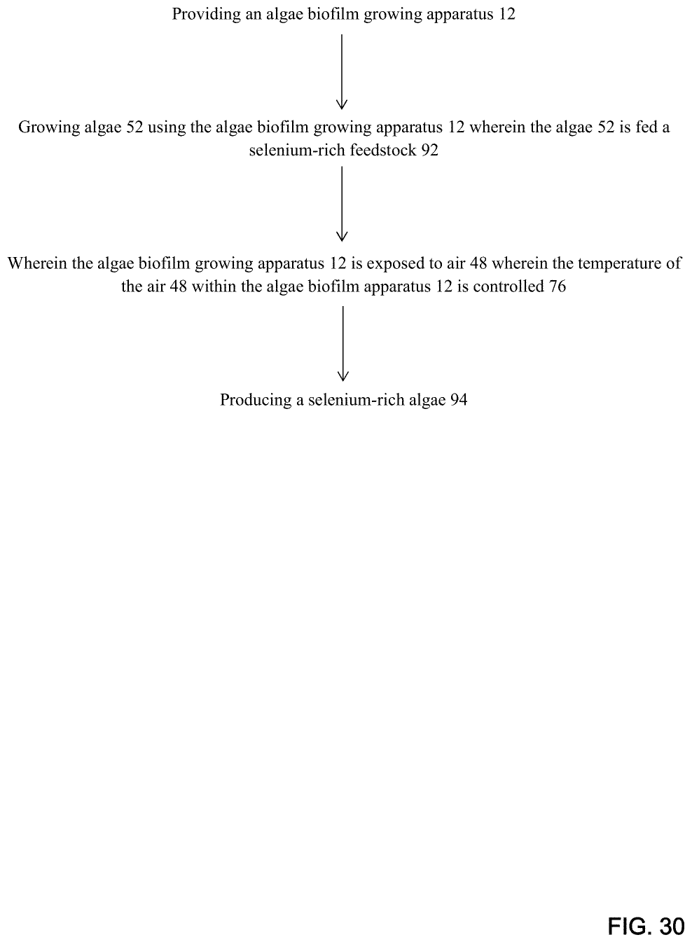

FIG. 31 depicts a flow chart illustrating a method associated with growing algae using an algae biofilm growing apparatus wherein the algae is fed a selenium-rich feedstock and the algae biofilm growing apparatus is exposed to light; wherein the light within the algae biofilm growing apparatus is controlled; wherein a selenium-rich algae is produced;

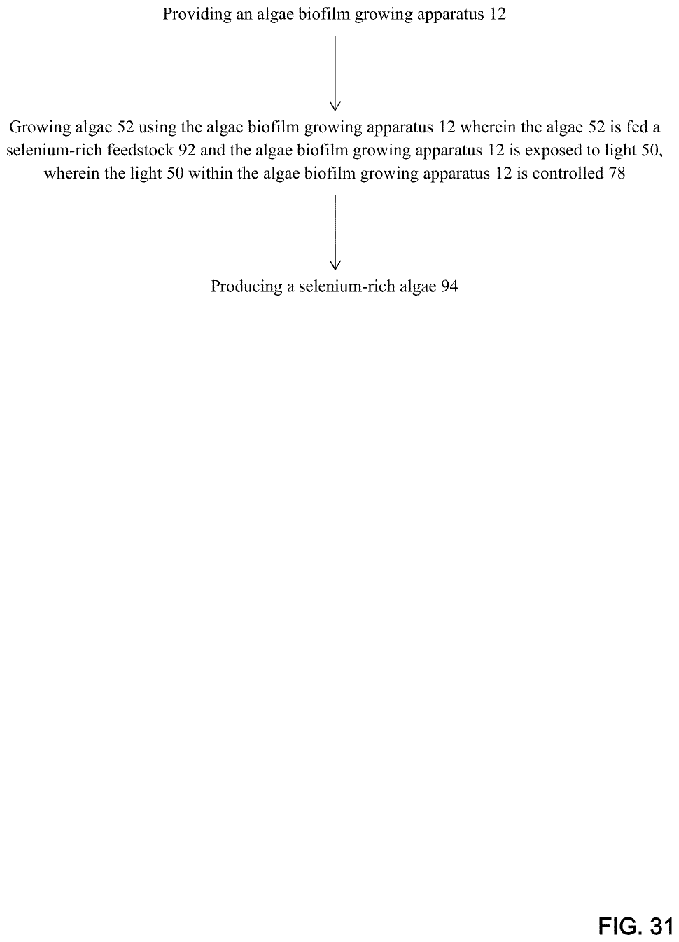

FIG. 32 depicts a flow chart illustrating a method associated with growing algae using an algae biofilm growing apparatus wherein the algae is fed a selenium-rich feedstock; wherein a selenium-rich algae is produced; wherein the selenium-rich algae is harvested and the harvested selenium-rich algae is used as a foodstuff for human or animal consumption;

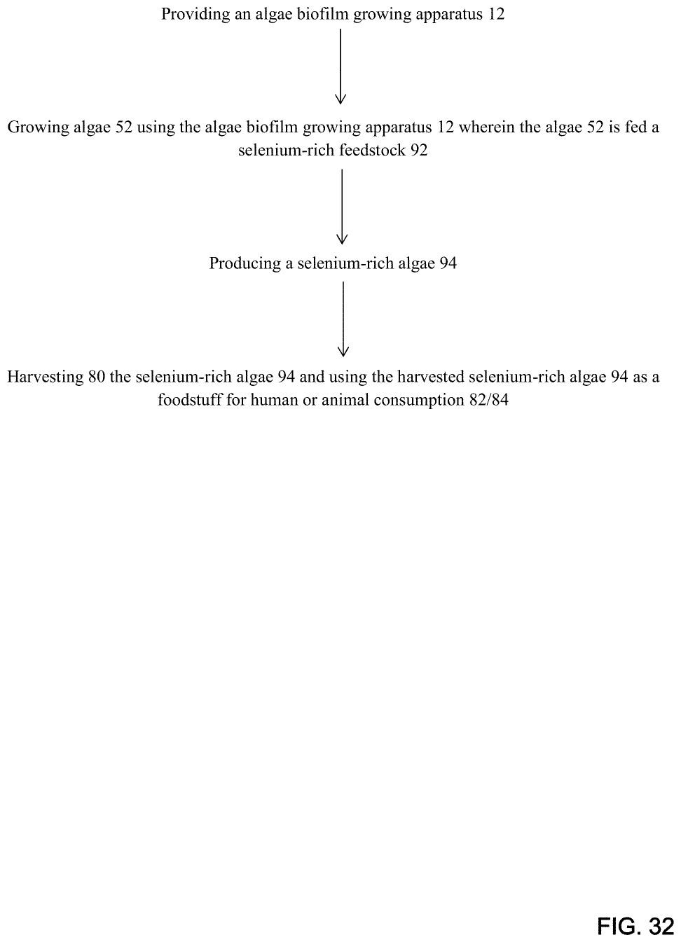

FIG. 33 depicts a flow chart illustrating a method associated with growing algae using an algae biofilm growing apparatus wherein the algae is fed a selenium-rich feedstock; wherein a selenium-rich algae is produced; wherein the algae is of the type referred to as Generally Regarded as Safe;

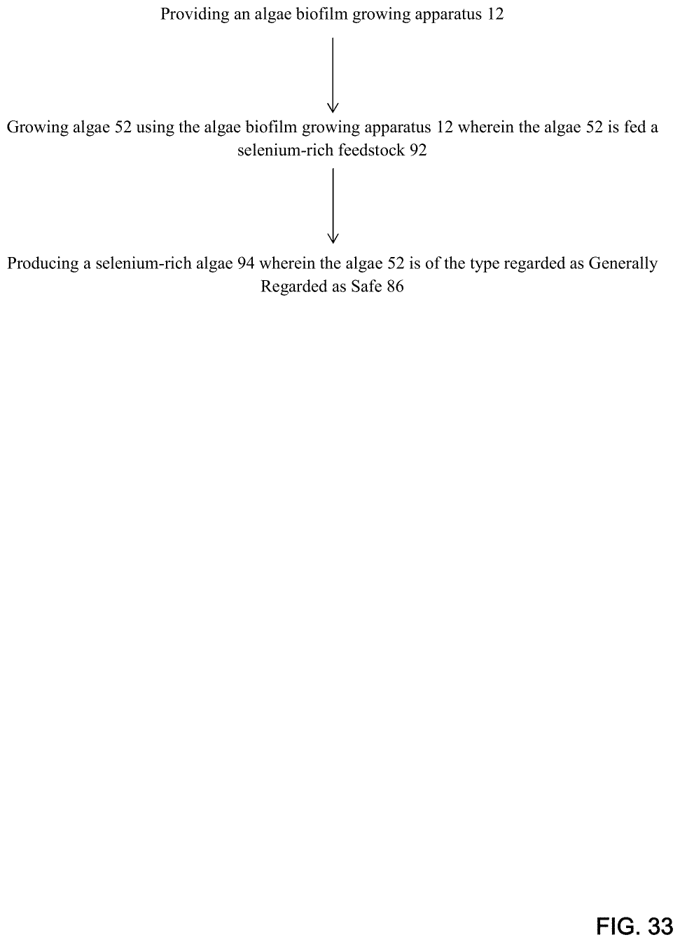

FIG. 34 depicts a flow chart illustrating a method associated with growing algae using an algae biofilm growing apparatus wherein the algae is fed a selenium-rich feedstock; wherein a selenium-rich algae is produced; wherein the algae is Chlorella algae;

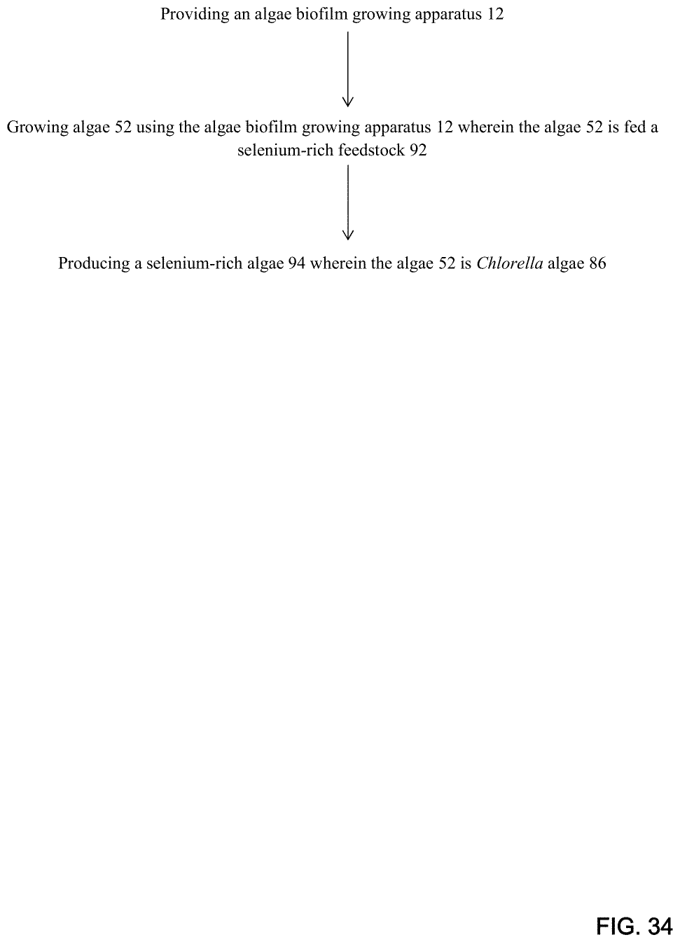

FIG. 35 depicts a flow chart illustrating a method associated with growing algae using an algae biofilm growing apparatus wherein the algae is fed a selenium-rich feedstock; wherein a selenium-rich algae is produced; wherein the algae is Spirulina algae;

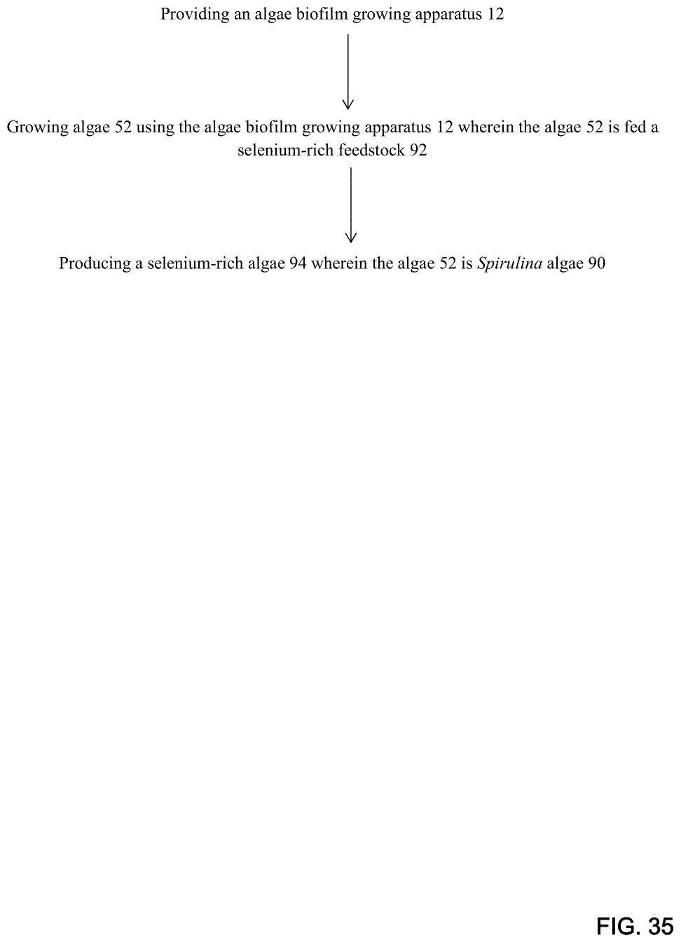

FIG. 36 depicts a flow chart illustrating a method associated with growing algae using an algae biofilm growing apparatus wherein the algae biofilm growing apparatus has a reservoir filled with fluid and at least one moving belt; wherein the at least one belt moves between a submerged position, wherein a portion of the at least one belt is submerged within the fluid held within the reservoir, and an exposed position wherein a portion of the at least one belt is not submerged within the fluid held within the reservoir; wherein a portion of the at least one belt is exposed to air and light; wherein algae grows on a biofilm as the at least one belt moves through the algae biofilm growing apparatus wherein the algae is fed a selenium-rich feedstock thereby growing a selenium-rich algae;

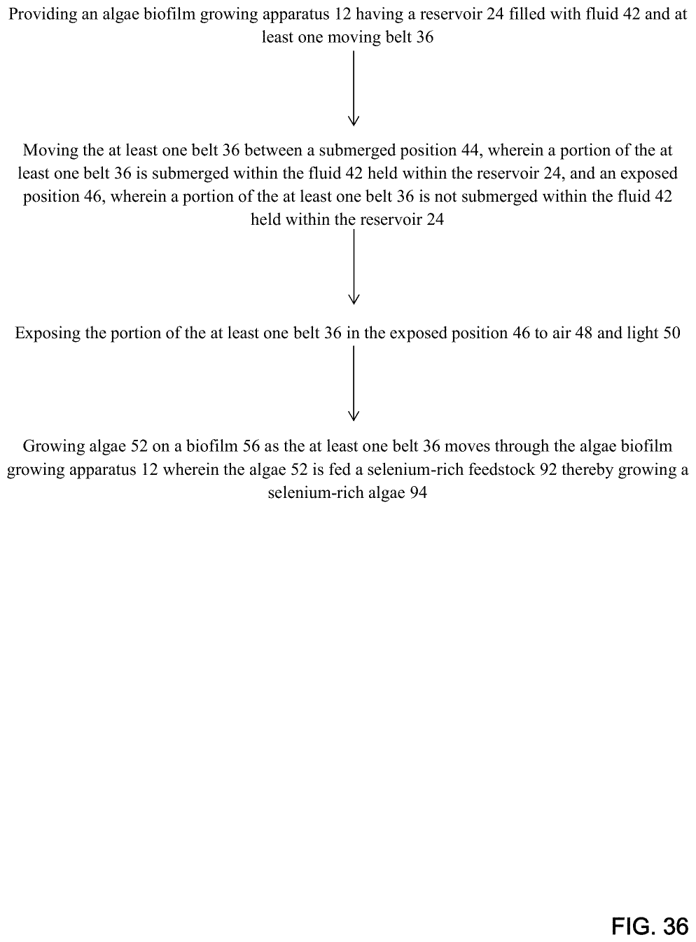

FIG. 37 depicts a flow chart illustrating a method associated with growing algae using an algae biofilm growing apparatus having a reservoir filled with fluid and at least one moving belt; moving the at least one belt between a submerged position, wherein a portion of the at least one belt is submerged within the fluid held within the reservoir, and an exposed position, wherein a portion of the at least one belt is not submerged within the fluid held within the reservoir; exposing the portion of the at least one belt in the exposed position to air and light; growing algae on a biofilm as the at least one belt moves through the algae biofilm growing apparatus wherein the algae is fed a selenium-rich feedstock; growing a selenium-rich algae wherein the selenium-rich feedstock is an inorganic selenium;

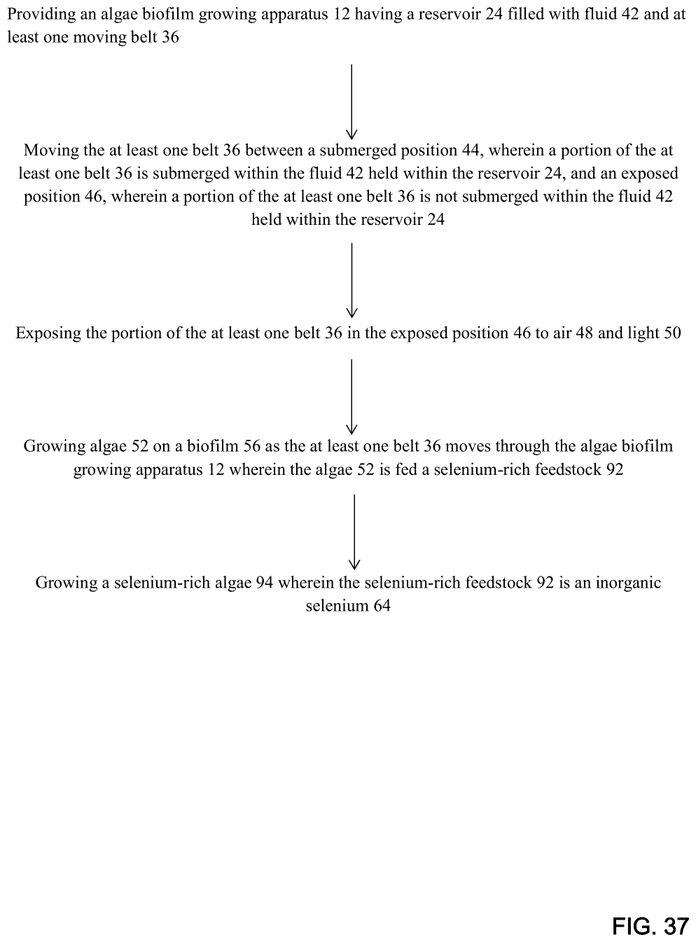

FIG. 38 depicts a flow chart illustrating a method associated with growing algae using an algae biofilm growing apparatus having a reservoir filled with fluid and at least one moving belt; wherein the at least one belt is moved between a submerged position, wherein a portion of the at least one belt is submerged within the fluid held within the reservoir, and an exposed position, wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein the selenium-rich feedstock includes a selenium salt; wherein a selenium-rich algae is grown;

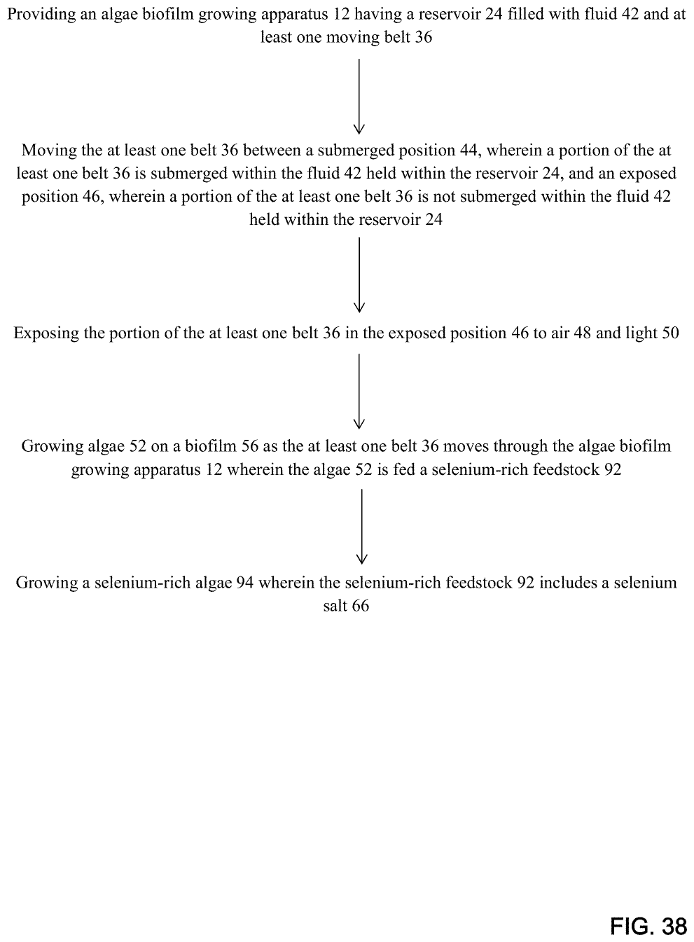

FIG. 39 depicts a flow chart illustrating a method associated with growing algae using an algae biofilm growing apparatus having a reservoir filled with fluid and at least one moving belt; wherein the at least one belt is moved between a submerged position, wherein a portion of the at least one belt is submerged within the fluid held within the reservoir, and an exposed position wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein the selenium-rich feedstock includes sodium selenite; wherein a selenium-rich algae is grown;

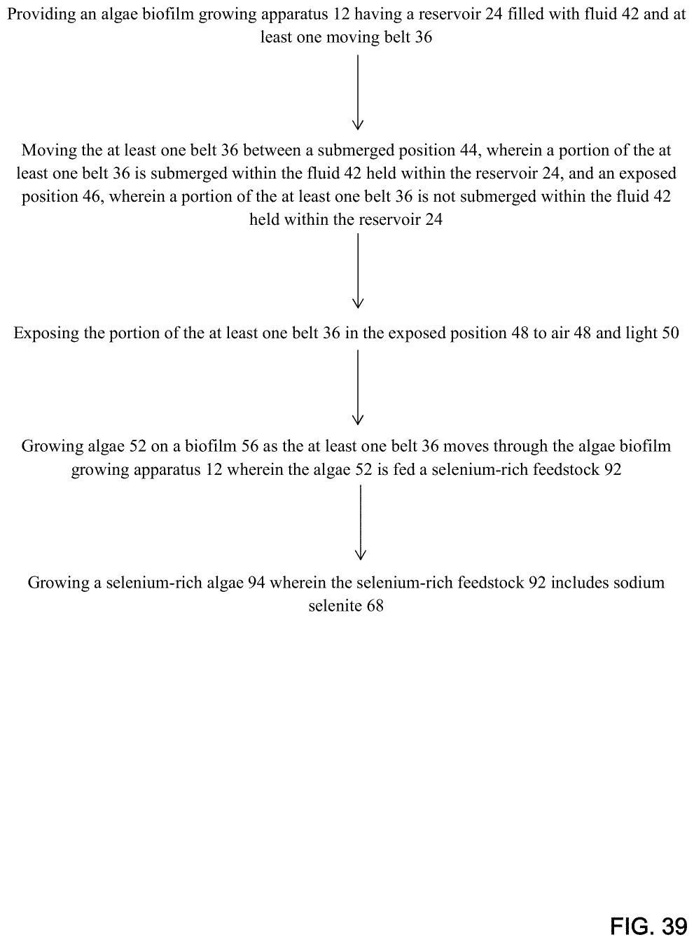

FIG. 40 depicts a flow chart illustrating a method associated with growing algae using an algae biofilm growing apparatus having a reservoir filled with fluid and at least one moving belt; wherein the at least one belt moves between a submerged position, wherein a portion of the at least one belt is submerged within the fluid held within the reservoir, and an exposed position, wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein the selenium-rich feedstock includes sodium selenate; wherein a selenium-rich algae is grown;

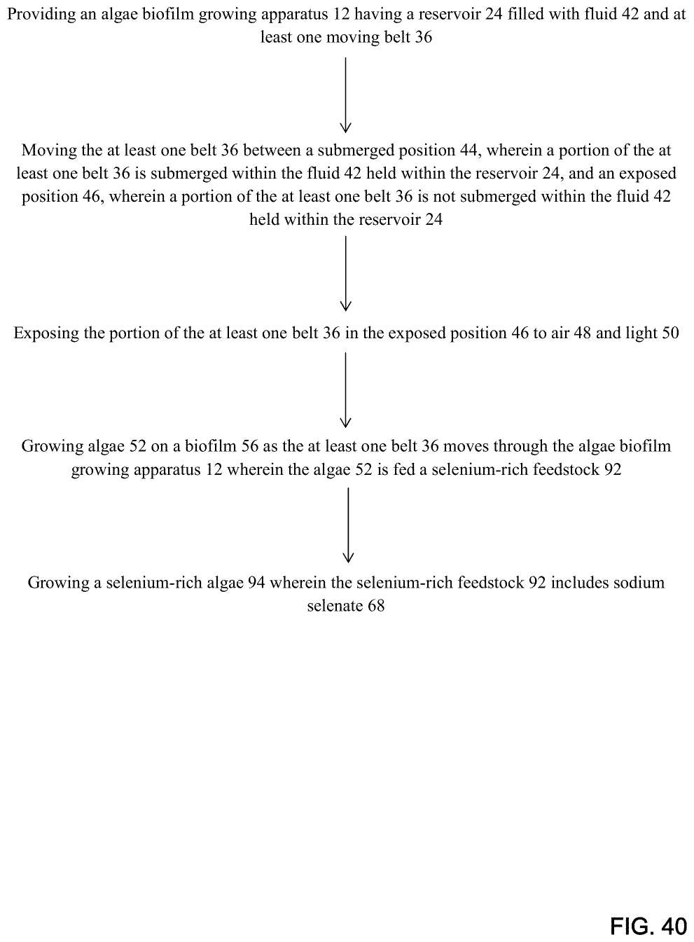

FIG. 41 depicts a flow chart illustrating a method associated with growing algae using an algae biofilm growing apparatus having a reservoir filled with fluid and at least one moving belt; wherein the at least one belt moves between a submerged position, wherein a portion of the at least one belt is submerged within the fluid held within the reservoir, and an exposed position, wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein the selenium-rich feedstock is an inorganic selenium; wherein the algae absorbs the inorganic selenium-rich feedstock thereby producing a bio-available selenium; wherein a selenium-rich algae is grown;

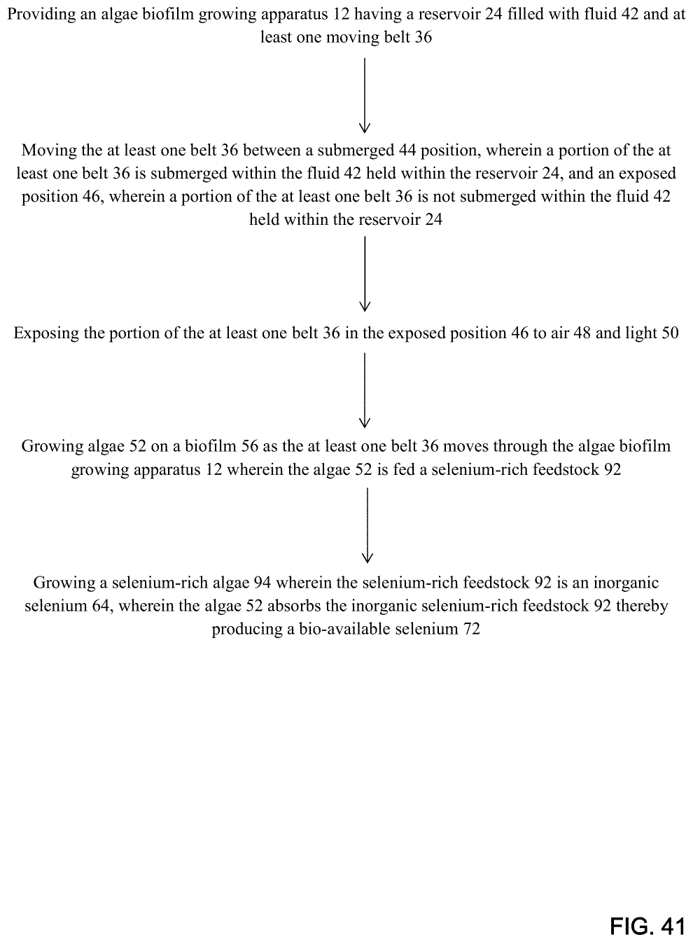

FIG. 42 depicts a flow chart illustrating a method associated with growing algae using an algae biofilm growing apparatus having a reservoir filled with fluid and at least one moving belt; wherein the at least one moving belt moves between a submerged position, wherein a portion of the at least one belt is submerged within the fluid held within the reservoir, and an exposed position, wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein the selenium-rich feedstock is an inorganic selenium; wherein the algae adsorbs the inorganic selenium-rich feedstock on the algae cells surface thereby producing a bio-available selenium; wherein a selenium-rich algae is grown;

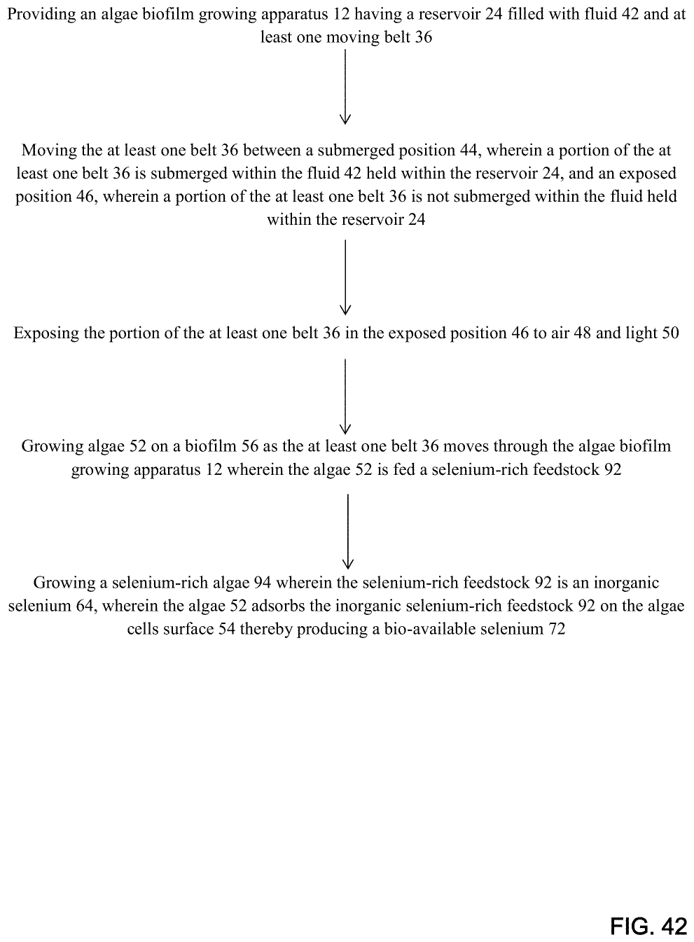

FIG. 43 depicts a flow chart illustrating a method associated with growing algae using an algae biofilm growing apparatus having a reservoir filled with fluid and at least one moving belt; wherein the at least one belt moves between a submerged position, wherein a portion of the at least one belt is submerged within the fluid held within the reservoir, and an exposed position, wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein the algae contains extracellular polymeric substances which enhance adsorption of selenium by the algae; wherein a selenium-rich algae is grown;

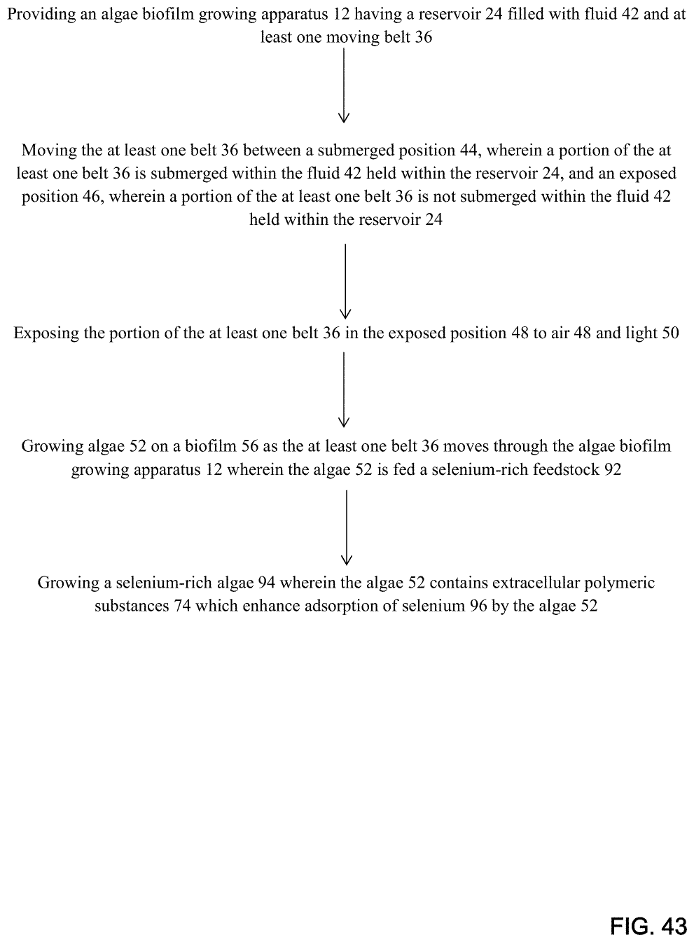

FIG. 44 depicts a flow chart illustrating a method associated with growing algae using an algae biofilm growing apparatus having a reservoir filled with fluid and at least one moving belt; wherein the at least one belt moves between a submerged position, wherein a portion of the at least one belt is submerged within the fluid held within the reservoir, and an exposed position wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein the algae contains extracellular polymeric substances which protect the algae from toxic effects of high concentrations of selenium in the fluid; wherein a selenium-rich algae is grown;

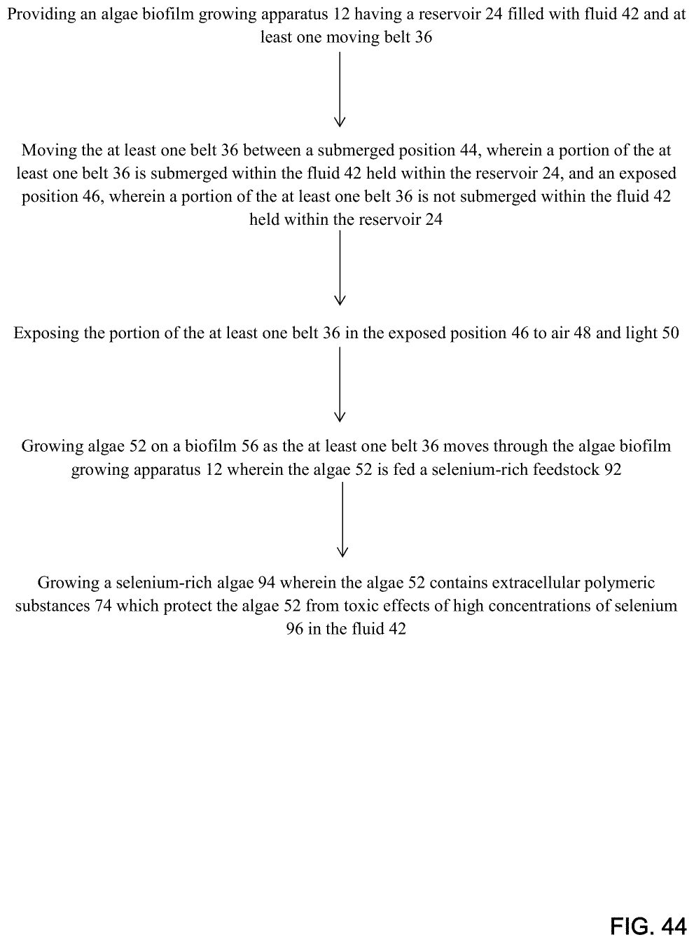

FIG. 45 depicts a flow chart illustrating a method associated with growing algae using an algae biofilm growing apparatus having a reservoir filled with fluid and at least one moving belt; wherein the temperature of the fluid within the reservoir is controlled; wherein the at least one belt moves between a submerged position, wherein a portion of the at least one belt is submerged with the fluid held within the reservoir, and an exposed position, wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein a selenium-rich algae is grown;

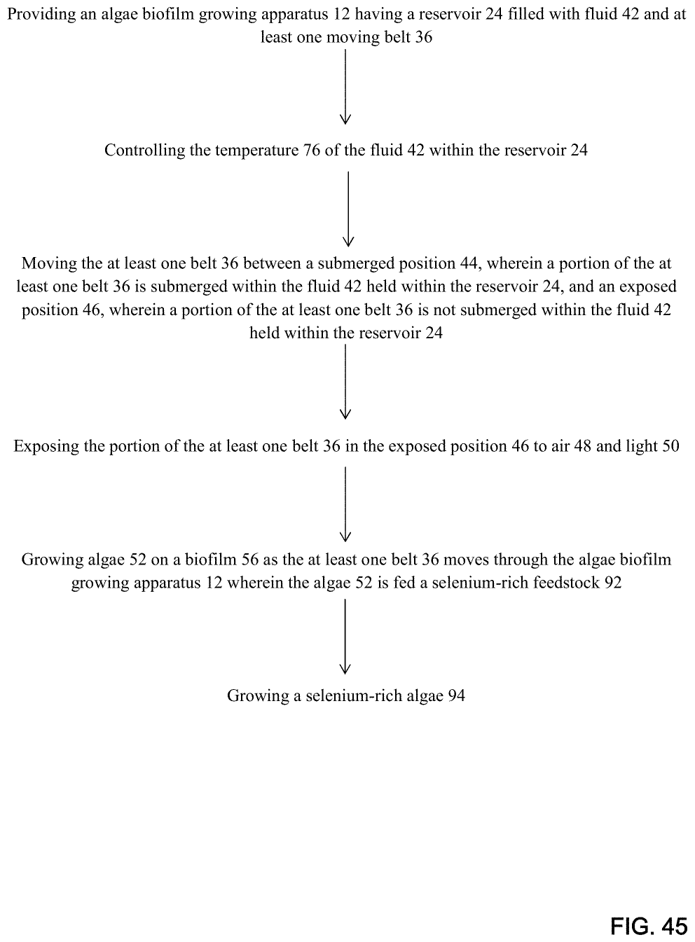

FIG. 46 depicts a flow chart illustrating a method associated with growing algae using an algae biofilm growing apparatus having a reservoir filled with fluid and at least one moving belt; wherein the light within the algae biofilm growing apparatus is controlled; wherein the at least one belt moves between a submerged position, wherein a portion of the at least one belt is submerged within the fluid held within the reservoir, and an exposed position, wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein a selenium-rich algae is grown;

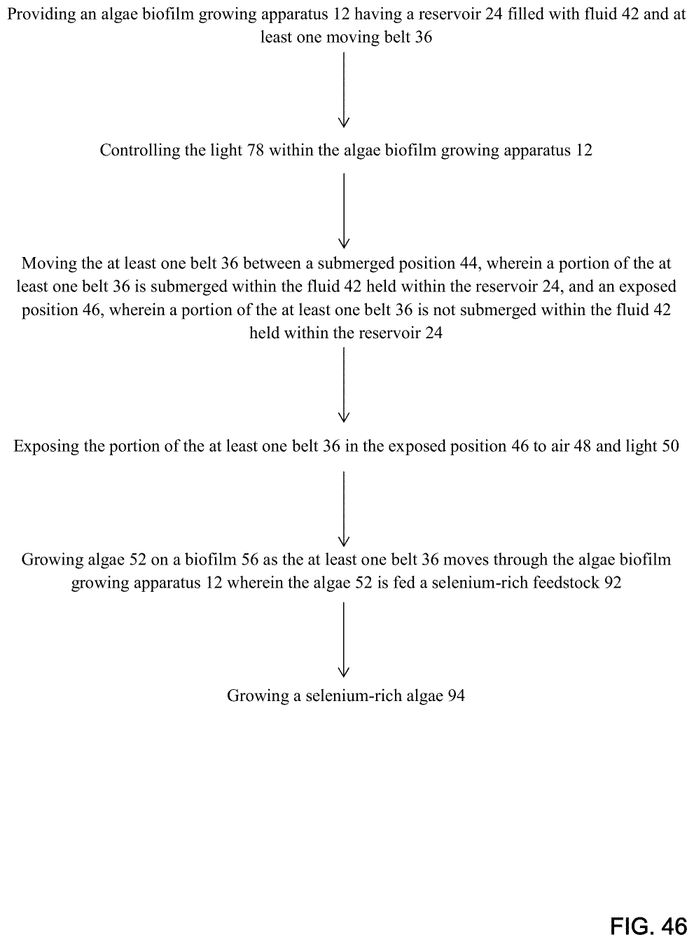

FIG. 47 depicts a flow chart illustrating a method associated with growing algae using an algae biofilm growing apparatus having a reservoir filled with fluid and at least one moving belt; wherein the at least one moving belt moves between a submerged position, wherein a portion of the at least one belt is submerged within the fluid held within the reservoir, and an exposed position, wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein a selenium-rich algae is grown; wherein the selenium-rich algae is harvested;

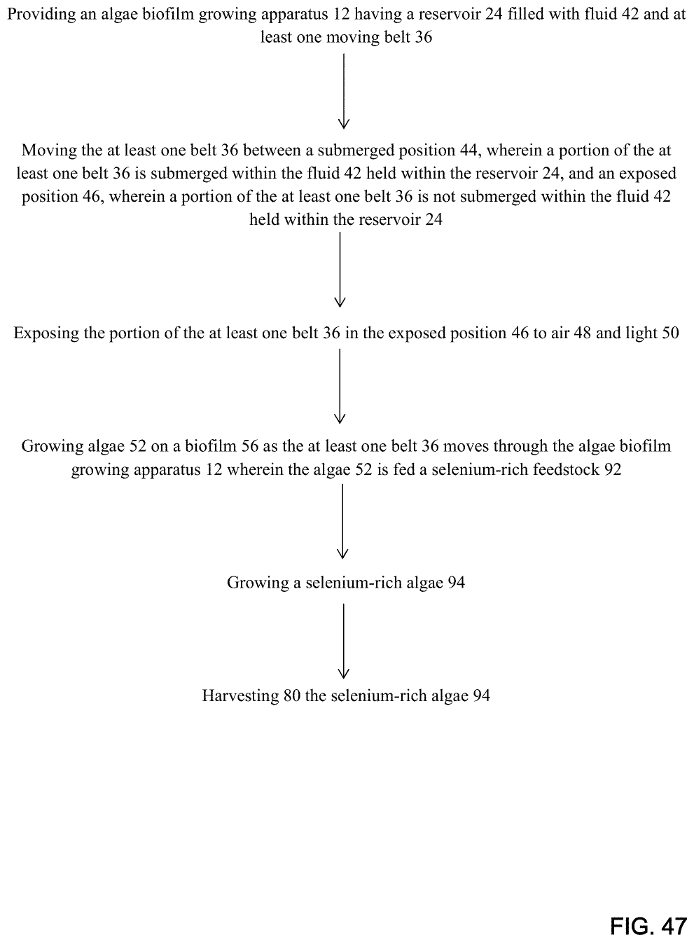

FIG. 48 depicts a flow chart illustrating a method associated with growing algae using an algae biofilm growing apparatus having a reservoir filled with fluid and at least one moving belt; wherein the at least one belt moves between a submerged position, wherein a portion of the at least one belt is submerged within the fluid held within the reservoir, and an exposed position, wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein a selenium-rich algae is grown; wherein the selenium-rich algae is harvested by scraping a blade along the at least one belt and using the harvested selenium-rich algae as a foodstuff for human or animal consumption;

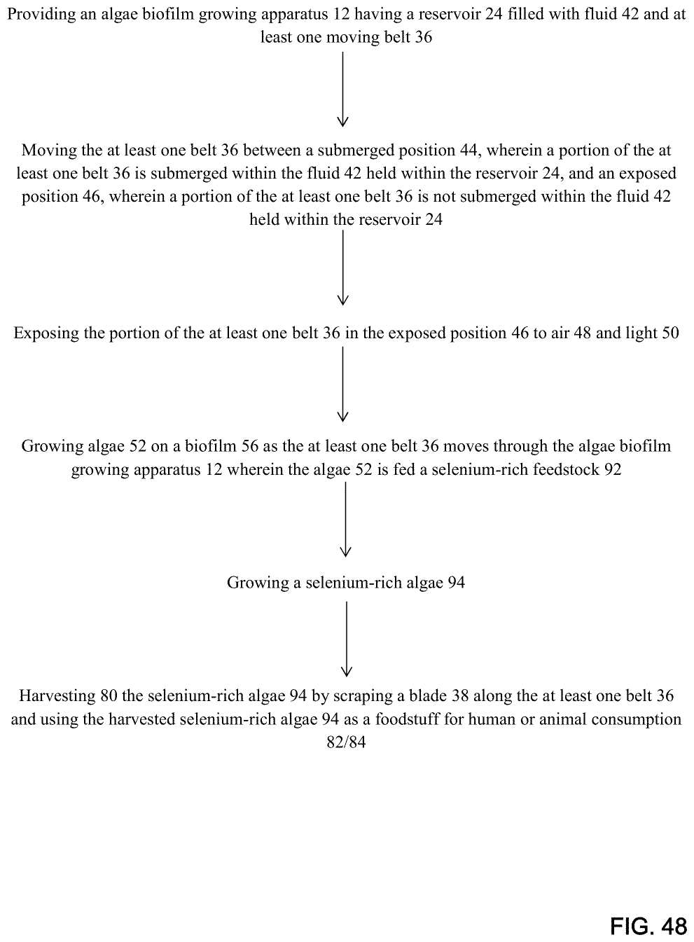

FIG. 49 depicts a flow chart illustrating a method associated with growing algae using an algae biofilm growing apparatus having a reservoir filled with fluid and at least one moving belt; wherein the at least one belt moves between a submerged position, wherein a portion of the at least one belt is submerged within the fluid held within the reservoir, and an exposed position, wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein the algae is of the type regarded as Generally Regarded as Safe; wherein a selenium-rich algae is grown;

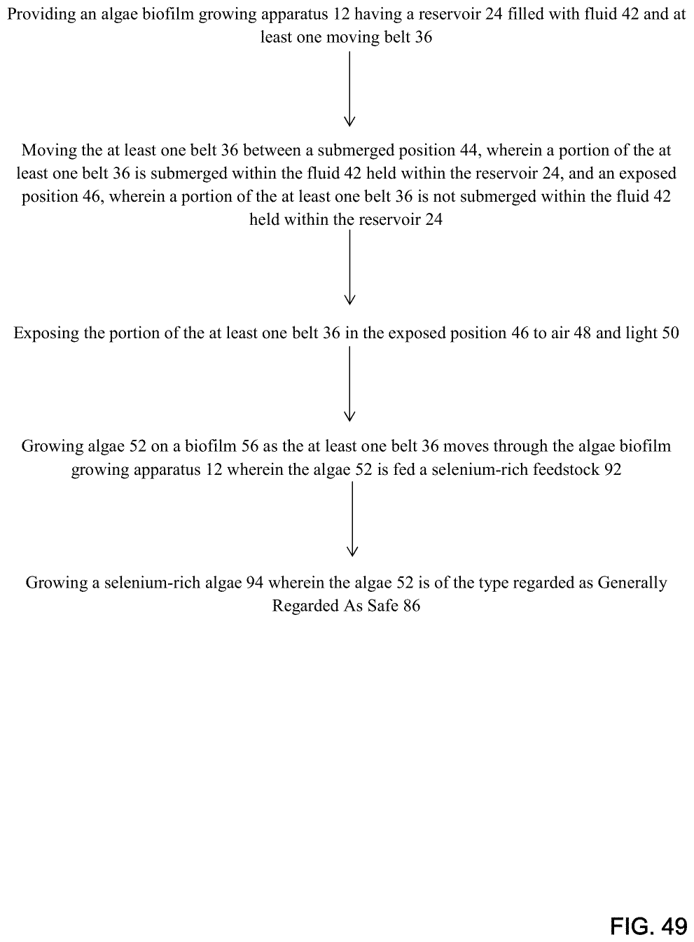

FIG. 50 depicts a flow chart illustrating a method associated with growing algae using an algae biofilm growing apparatus having a reservoir filled with fluid and at least one moving belt; wherein the at least one belt moves between a submerged position, wherein a portion of the at least one belt is submerged with the fluid held within the reservoir, and an exposed position, wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein a selenium-rich algae is grown; wherein the algae is Chlorella algae;

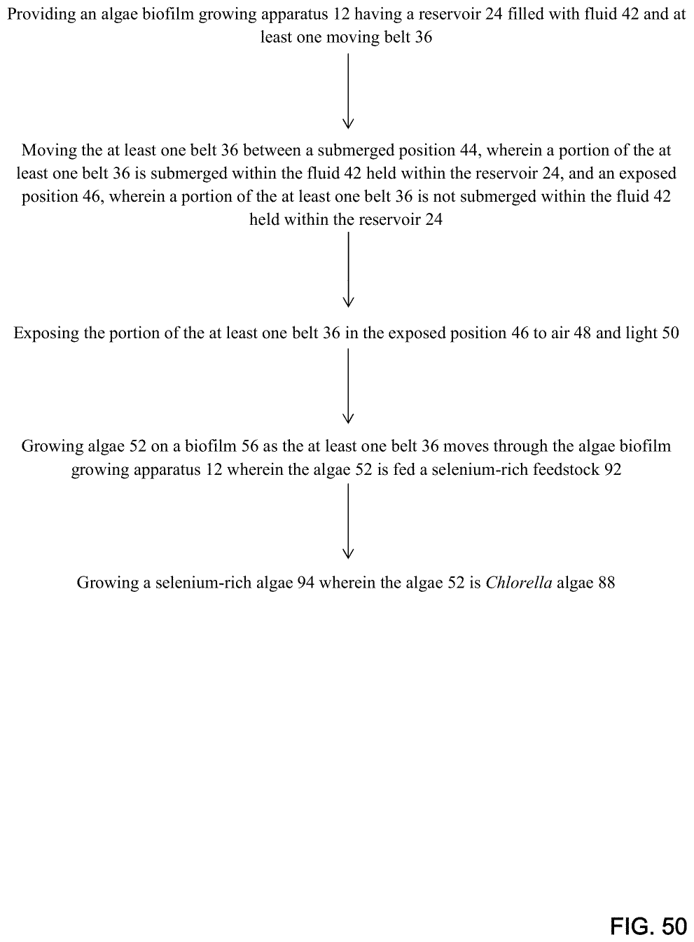

FIG. 51 depicts a flow chart illustrating a method associated with growing algae using an algae biofilm growing apparatus having a reservoir filled with fluid and at least one moving belt; wherein the at least one belt moves between a submerged position, wherein a portion of the at least one belt is submerged within the fluid held within the reservoir, and an exposed position, wherein a portion of the at least one belt is not submerged within the fluid held within the reservoir; wherein the portion of the at least one belt in the exposed position is exposed to air and light; wherein algae is grown on a biofilm as the at least one belt moves through the algae biofilm growing apparatus wherein the algae is fed a selenium-rich feedstock; wherein a selenium-rich algae is grown; wherein the algae is Spirulina algae;

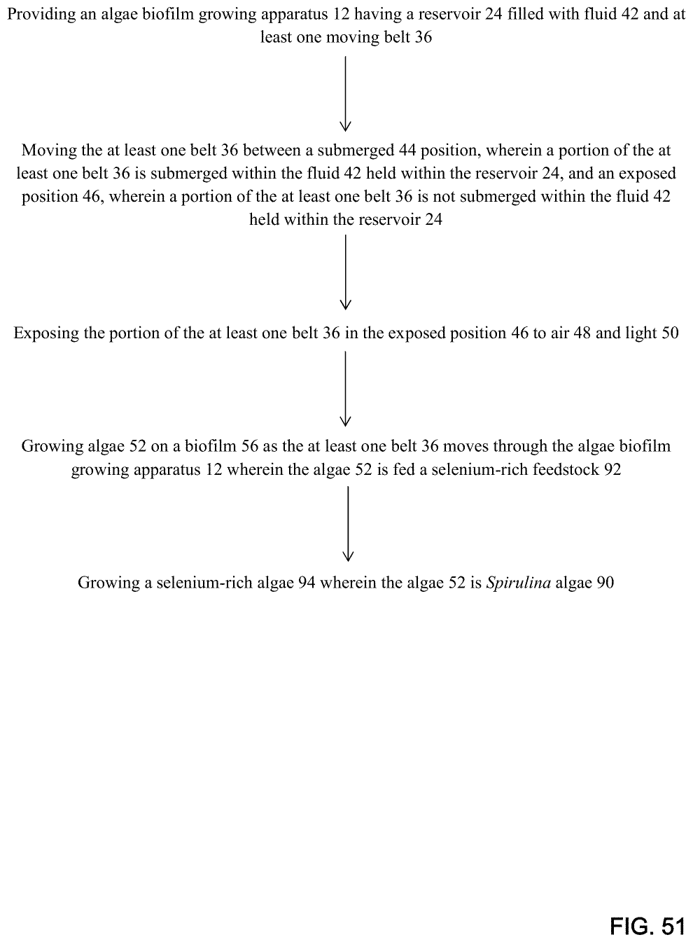

FIG. 52 depicts a flow chart illustrating a method associated with growing a mineral-rich algae wherein algae is grown using an algae biofilm growing apparatus; wherein the algae is fed a mineral-rich feedstock; thereby producing a mineral-rich algae;

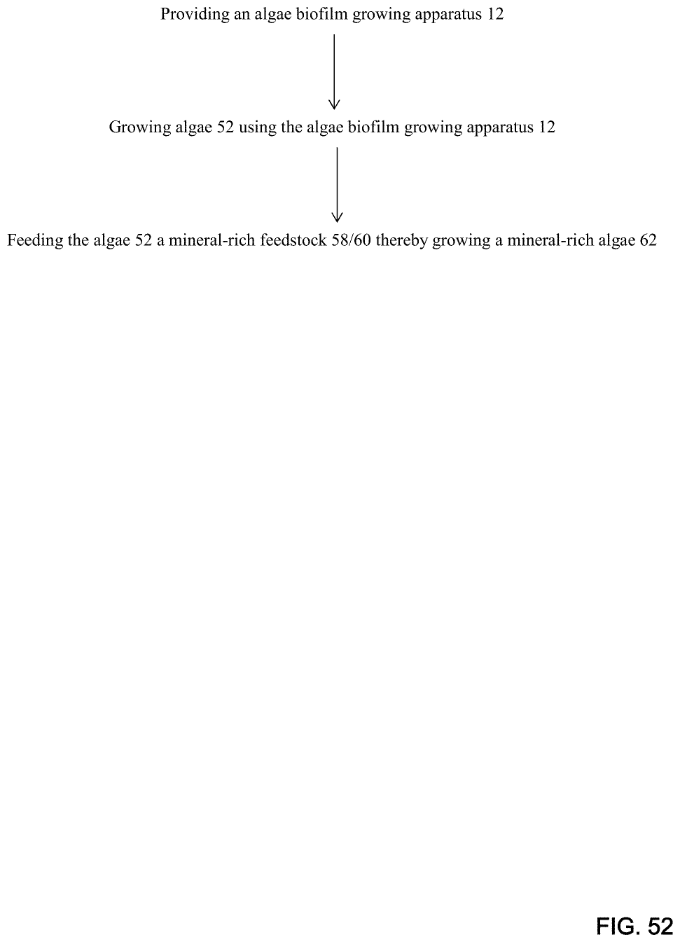

FIG. 53 depicts a flow chart illustrating a method associated with growing a mineral-rich algae using an algae biofilm growing apparatus having a reservoir filled with fluid and at least one moving belt; wherein the at least one belt moves between a submerged position, wherein a portion of the at least one belt is submerged within the fluid held within the reservoir, and an exposed position, wherein a portion of the at least one belt is not submerged within the fluid held within the reservoir; wherein the portion of the at least one belt in the exposed position is exposed to air and light; wherein algae is grown using a biofilm as the at least one belt moves through the algae biofilm growing apparatus wherein the algae is fed a mineral-rich feedstock; wherein a mineral-rich algae is grown;

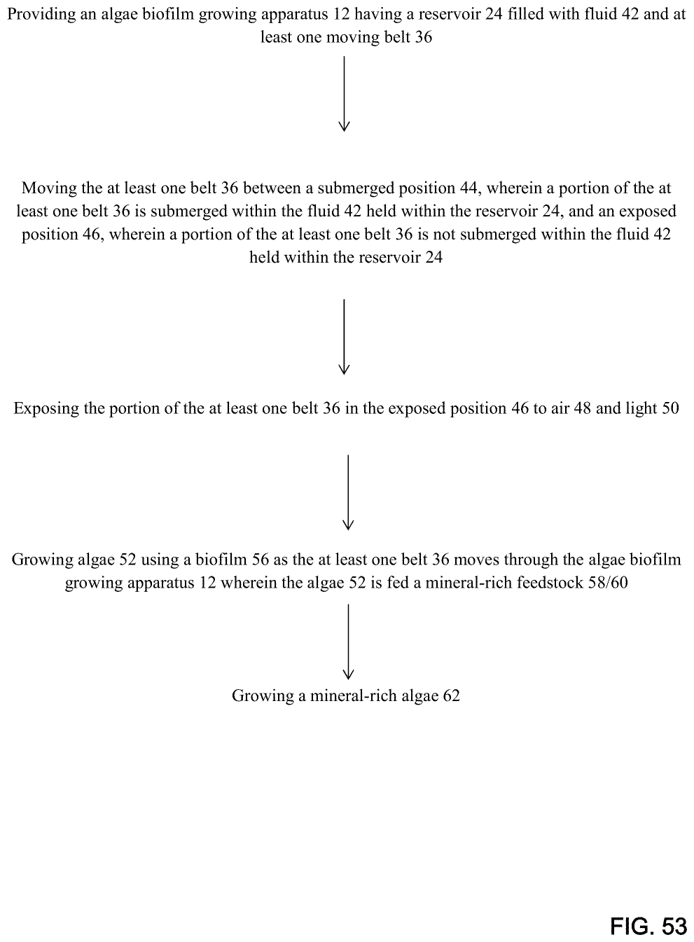

FIG. 54 depicts a flow chart illustrating a method associated with growing algae utilizing any type of process or mechanism; wherein the algae is harvested and a mineral-rich fluid is added to the algae resulting in an algae slurry; wherein the algae is allowed to absorb the mineral(s) from the mineral-rich fluid; wherein a mineral-rich algae is produced;

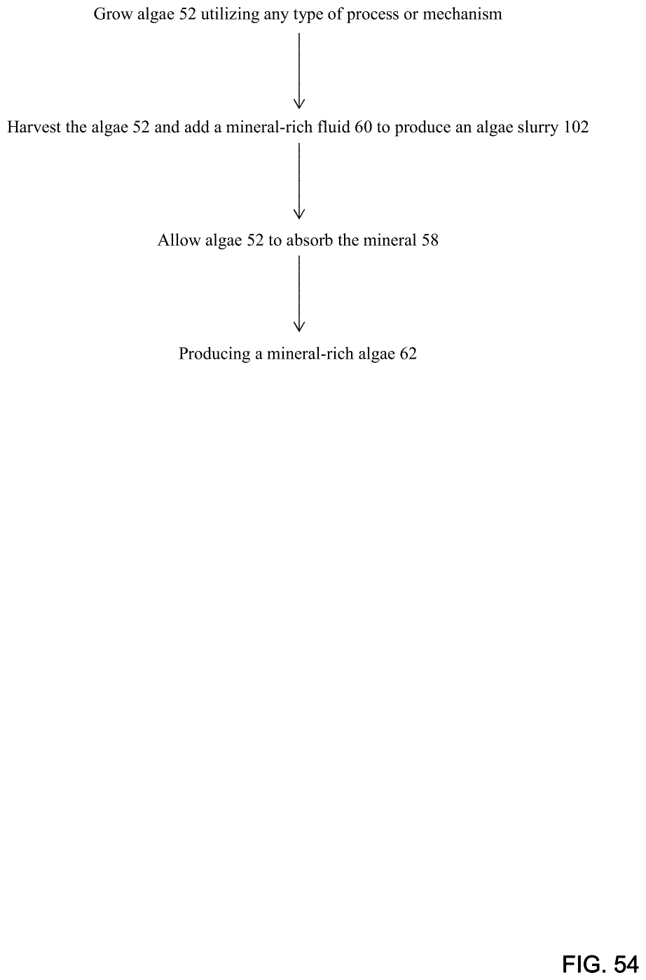

FIG. 55 depicts a flow chart illustrating a method associated with growing algae utilizing any type of process or mechanism; wherein the algae is harvested and a selenium-rich fluid is added to the algae resulting in an algae slurry; wherein the algae is allowed to absorb the selenium from the selenium-rich fluid; wherein a selenium-rich algae is produced;

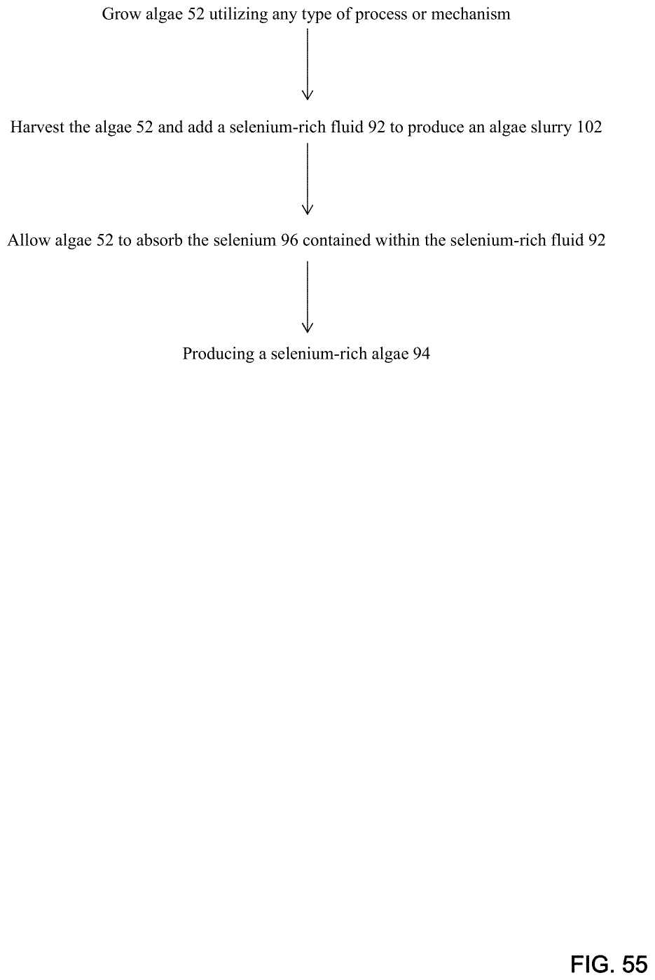

FIG. 56 depicts a bar graph illustrating a comparison of the biomass productivity (g/week) of attached-algae (also referred to as algae in a biofilm) and suspended-algae (also referred to as algae that is suspended in a fluid); the bar graph illustrates the biomass productivity of attached-algae is consistently greater than the biomass productivity of suspended-algae at different concentrations of selenium in the medium; the bar graph also illustrates in a medium comprising a selenium concentration of 200 mg/L, the attached-algae is alive while the suspended-algae is dead;

FIG. 57 depicts visual representations which illustrate attached-algae can tolerate 200 mg/L of selenium while suspended-algae dies when confronting 200 mg/L of selenium;

FIG. 58 depicts a bar graph illustrating the selenium content in attached-algae and suspended-algae when cells are cultured under different concentrations of selenium;

FIG. 59 depicts a bar graph illustrating a comparison of selenium bio-availability for selenium supplements from different sources;

FIG. 60 depicts a bar graph illustrating a comparison of the extracellular polymeric substances (EPS) content in attached-algae and suspended-algae;

FIG. 61 depicts a visual representation illustrating the confocal laser-scanning microscopy (CLSM) images of biomass in attached-algae and suspended-algae;

FIG. 62 depicts a table illustrating a comparison of the minerals content (% minerals in dry-based algal biomass) in attached-algae and suspended-algae when cultured under different concentrations of selenium; wherein attached-algae contains more calcium and iron than suspended-algae; wherein, when cultured in a selenium-rich medium (such as Bold's Basil medium which comprises 200 mg/L of selenium), suspended-algae is dead while attached-algae survived and demonstrates boosted selenium and iron content in the biomass.

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the disclosure.

Furthermore, as used herein, the term “absorption” shall mean to consume, bring inside, or soak up; whereas the term “adsorption” shall mean the adhesion of molecules including, but not limited to, gases, solutes, or liquids, to the outer surface of a cell which they are in contact.

Mineral Supplementation in Algae System

In the arrangement shown, as one example, a mineral supplementation in algae system 10 (or simply “system” 10) is formed of any suitable size, shape, and design and is configured to be utilized in association with any type of algae growing apparatus such as an algae biofilm growing apparatus 12. In one arrangement, as shown, the system 10 comprises an algae biofilm growing apparatus 12, algae 52, and a mineral-rich feedstock 60.

In one arrangement, as one example, the system 10 comprises the steps of: providing an algae biofilm growing apparatus 12, growing algae 52 using the algae biofilm growing apparatus 12, feeding the algae 52 a mineral-rich feedstock 60 thereby growing a mineral-rich algae 62.

In one example, the system 10 comprises the steps of: providing an algae biofilm growing apparatus 12, growing algae 52 using the algae biofilm growing apparatus 12, feeding the algae 52 a selenium-rich feedstock 92 thereby growing a selenium-rich algae 94.

Additionally, in one arrangement, as an example, the system 10 comprises the steps of: providing an algae biofilm growing apparatus 12 having a reservoir 24 filled with fluid 42 and at least one moving belt 36; moving the at least one belt 36 between a submerged position 44, wherein a portion of the at least one belt 36 is submerged within the fluid 42 held within the reservoir 24, and an exposed position 46, wherein a portion of the at least one belt 36 is not submerged within the fluid 42 held within the reservoir 24; exposing the portion of the at least one belt 36 in the exposed position 46 to air 48 and light 50; growing algae 52 as an algae biofilm 56 as the at least one moving belt 36 moves through the algae biofilm growing apparatus 12; and feeding the algae 52 a mineral-rich feed stock 60 thereby growing a mineral-rich algae 62.

Furthermore, in one arrangement, as one example, the system 10 comprises the steps of: providing an algae biofilm growing apparatus 12 having a reservoir 24 filled with fluid 42 and at least one moving belt 36; moving the at least one belt 36 between a submerged position 44, wherein a portion of the at least one belt 36 is submerged within the fluid 42 held within the reservoir 24, and an exposed position 46, wherein a portion of the at least one belt 36 is not submerged within the fluid 42 held within the reservoir 24; exposing the portion of the at least one belt 36 in the exposed position 46 to air 48 and light 50; growing algae 52 as an algae biofilm 56 as the at least one moving belt 36 moves through the algae biofilm growing apparatus 12; and feeding the algae 52 a selenium-rich feed stock 92 thereby growing a selenium-rich algae 94.

In another arrangement, as one example, the system 10 comprises the steps of: growing algae 52 utilizing any type of process or mechanism including, but not limited to, an algae biofilm growing apparatus 12, harvesting the algae 52 and adding a selenium-rich fluid 92 to the algae in order to produce an algae slurry 102; allowing the algae 52 to absorb the selenium 96 contained within the selenium-rich fluid 92 thereby growing a selenium-rich algae 94.

Furthermore, another arrangement of the system 10, as one example, comprises the steps of: growing algae 52 utilizing any type of process or mechanism including, but not limited to, an algae biofilm growing apparatus 12; harvesting the algae 52 and adding a mineral-rich fluid 60 to the algae in order to produce an algae slurry 102; allowing the algae 52 to absorb the minerals 58 contained within the mineral-rich fluid 60 thereby growing a mineral-rich algae 62.

Algae

The system 10 is capable of producing a mineral-rich algae 62. In one arrangement, the system 10 is capable of producing a mineral-rich algae 62 by providing an algae biofilm growing apparatus 12, growing algae 52 using the algae biofilm growing apparatus 12, and feeding the algae 52 a mineral-rich feed stock 60 thereby growing a mineral-rich algae 62. In another arrangement, as described above, the system 10 is capable of producing a mineral-rich algae 62 by growing algae 52 utilizing any type of process or mechanism, harvesting the algae 52 and adding a mineral-rich fluid 60 to the algae to produce an algae slurry 102, allowing the algae 52 to absorb the minerals 58 contained within the mineral-rich fluid 60 thereby growing a mineral-rich algae 62.

Any species or type of algae 52 may be utilized in the system 10 without departing from the scope of the disclosure. In one arrangement, as one example, the algae 52 may be Chlorella algae 88 or Spirulina algae 90. Additionally, in one arrangement, the algae 52 may be of the type regarded as Generally Regarded As Safe 86. In yet another arrangement, as one example, the algae 52 may comprise more than one species of algae without departing from the scope of the disclosure.

As stated above, any type of algae 52 may be utilized in the system 10. In one arrangement, as one example, biofilm based algae 56 (also referred to as “an algae biofilm”, “attached algae”, or “a biofilm”) may be utilized. Alternatively, in another arrangement, as one example, suspended algal culture systems (also referred to as “suspended algae”) may also be utilized without departing from the scope of the disclosure.

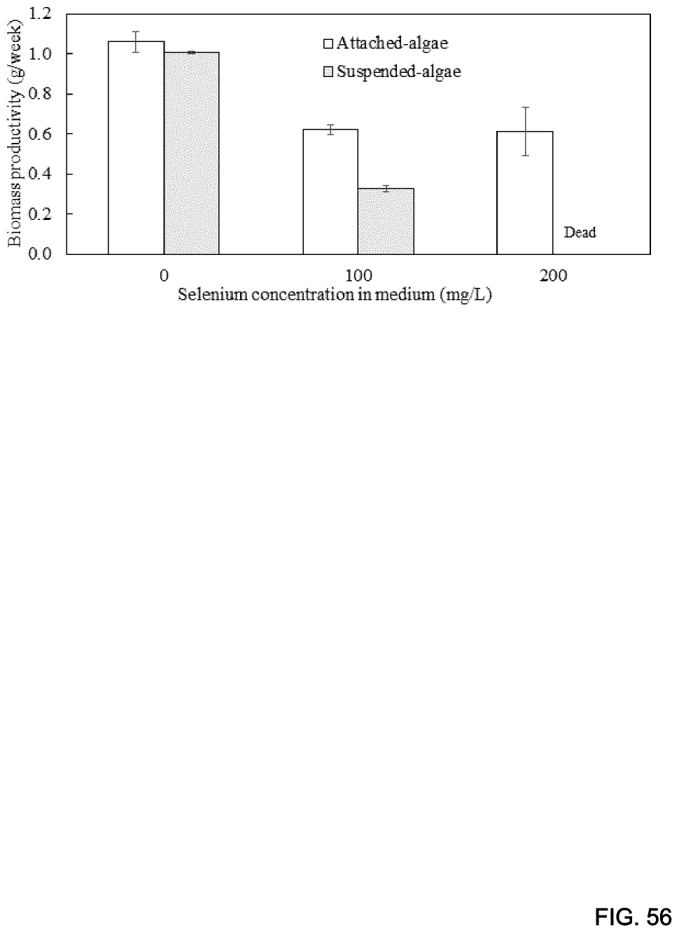

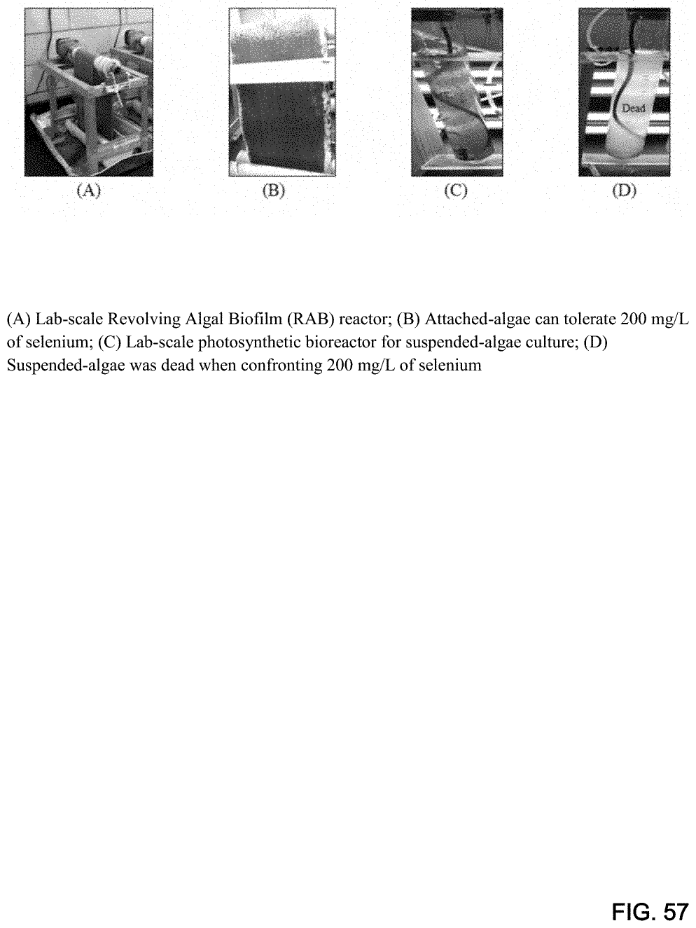

While the system 10 may utilize any type of algae 52 without departing from the scope of the disclosure including, but not limited to, an algae biofilm 56 or suspended algae, there are many advantages to utilizing an algae biofilm 56. Referring to FIG. 56, the biomass productivity (g/week) of attached algae 56 (also referred to as an algae biofilm 56) is consistently greater than the biomass productivity (g/week) of suspended algae when comparing the biomass productivity of attached algae 56 and suspended algae grown in mediums varying in concentrations of selenium. Furthermore, FIG. 56 demonstrates when biofilm algae 56 is grown in a medium comprising a selenium concentration of 200 mg/L the biofilm algae 56 is capable of surviving in an environment containing a high concentration of selenium whereas suspended algae is incapable of surviving in an environment containing a high concentration of selenium. Additionally, FIG. 57 provides a visual illustration of an algae biofilm 56 tolerating an environment containing 200 mg/L of selenium and the lack of tolerance of an environment containing 200 mg/L of selenium by suspended algae.

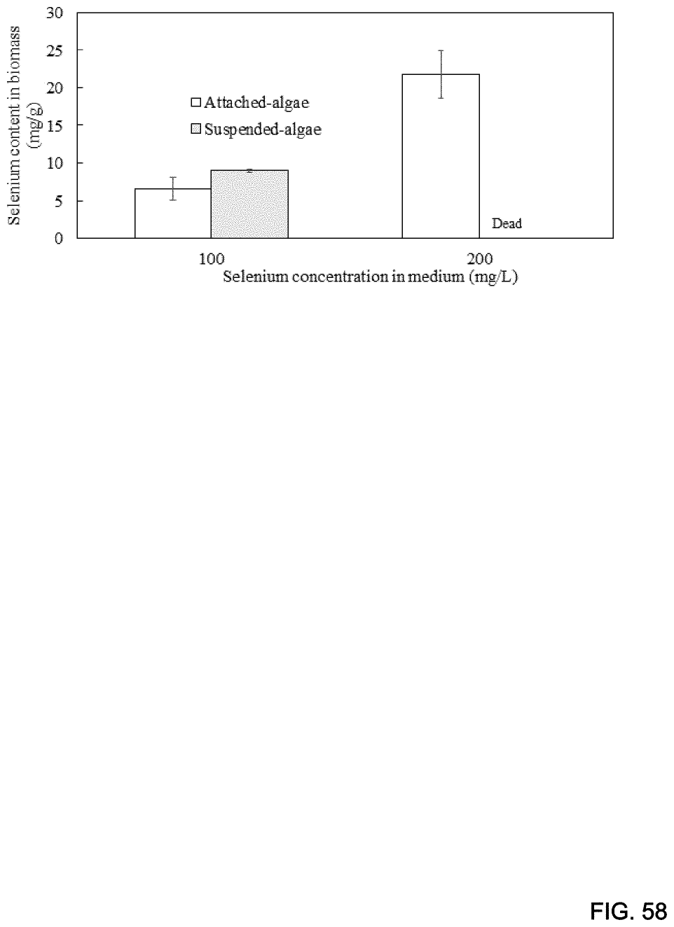

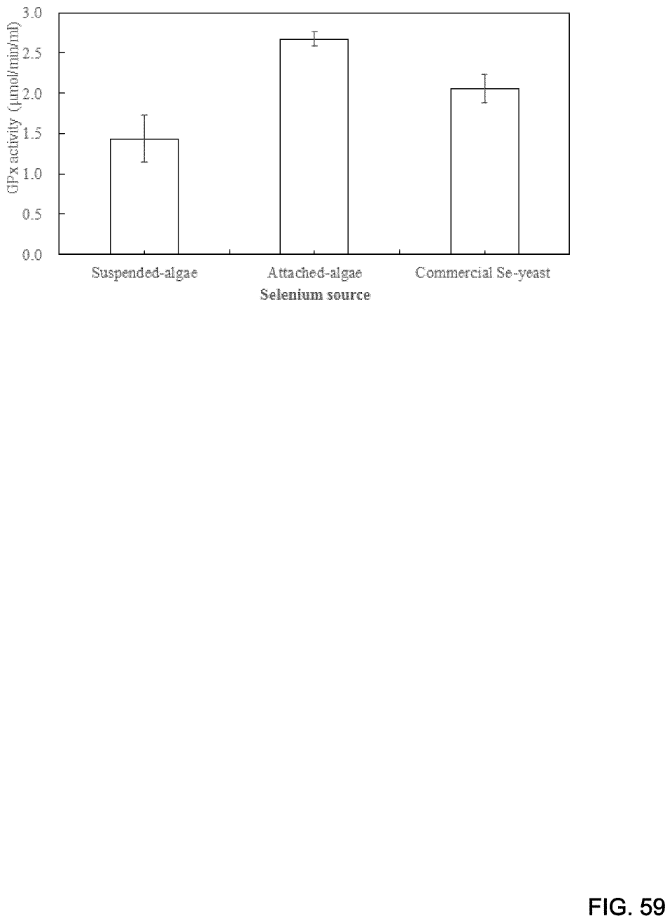

Referring to FIG. 58, when the selenium concentration in the medium is 100 mg/L then biofilm algae 56 and suspended algae are capable of survival. However, when the selenium concentration in the medium is increased to 200 mg/L then the biofilm algae 56 is capable of survival, but the suspended algae is not. Also, FIG. 59 demonstrates a comparison of selenium bio-availability for selenium supplements from different sources (i.e., suspended algae, attached algae or biofilm algae 56, and a commercial selenium yeast). In FIG. 59, Glutathione peroxidase (GPx) activity is analyzed as it is a common parameter to represent selenium bio-availability. The higher the GPx activity then the higher selenium bio-availability. Therefore, one can easily determine from FIG. 59 the biofilm algae 56 has an increased selenium bio-availability compared to suspended algae and the commercial selenium yeast. Also, it should be noted that the commercial selenium yeast utilized in FIG. 59 was a commercialized selenium supplement produced via yeast culture (Healthy Origins Selenium, Amazon, ASIN B0014B8GCI, ˜2 mg-Se/g-tablet).

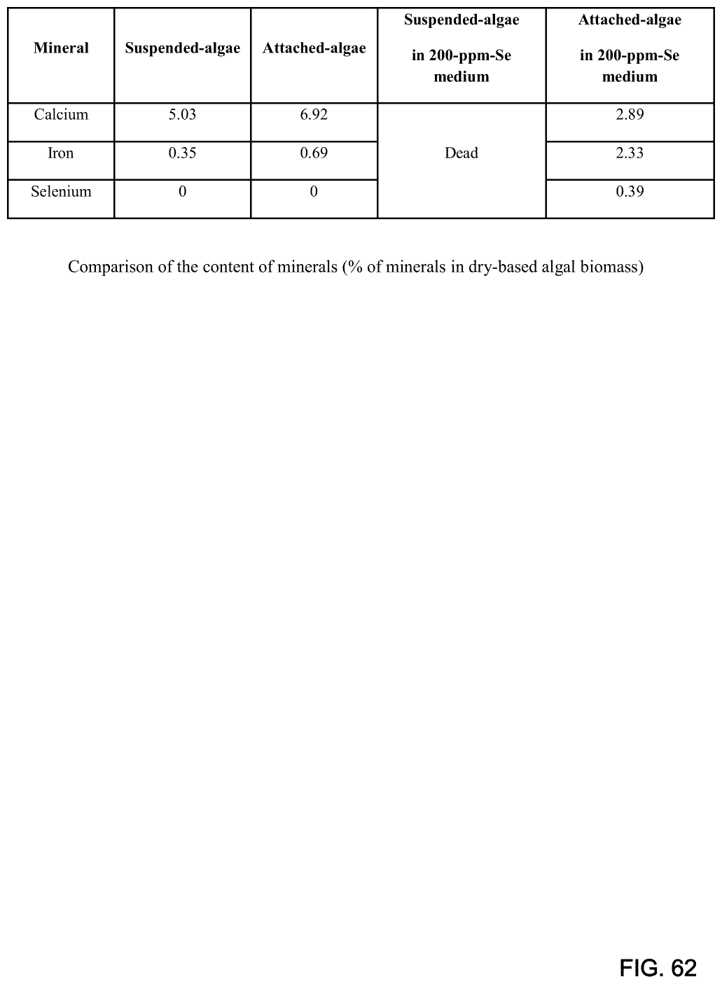

Another indication of biofilm algae 56 providing advantages when utilized within the system 10 can be found in FIG. 62. Referring to FIG. 62, when cultured in a selenium-rich medium (i.e., Bold's Basil medium comprising 200 mg/L of selenium), the suspended algae is dead while the attached algae 56 or biofilm algae 56 survives and shows boosted selenium and iron content in biomass.

Also, in one arrangement, as one example, the algae 52 contains extracellular polymeric substances 74 which enhance adsorption of minerals 58, including, but not limited to, selenium 96, by the algae 52. Additionally, in one arrangement, the algae 52 contains extracellular polymeric substances (EPS) 74 which protect the algae 52 from toxic effects of high concentrations of minerals 58, such as selenium 96.

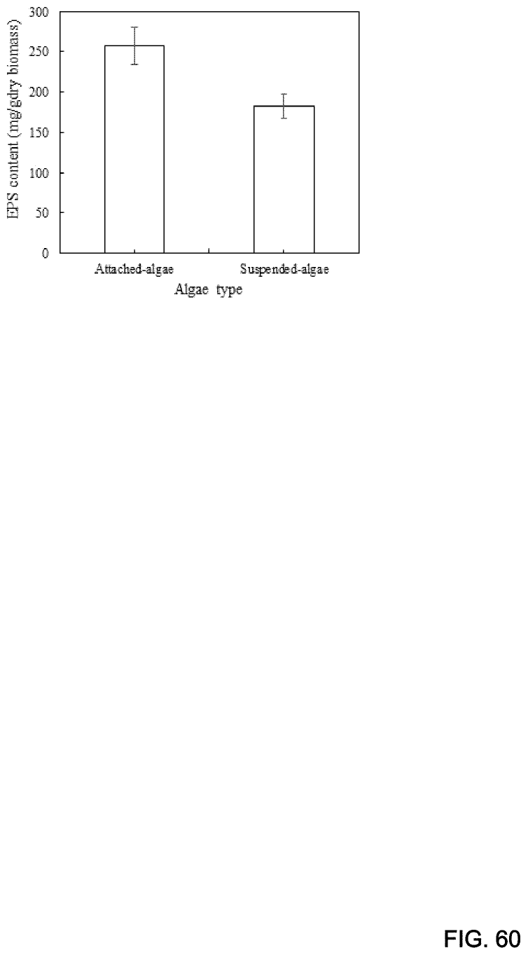

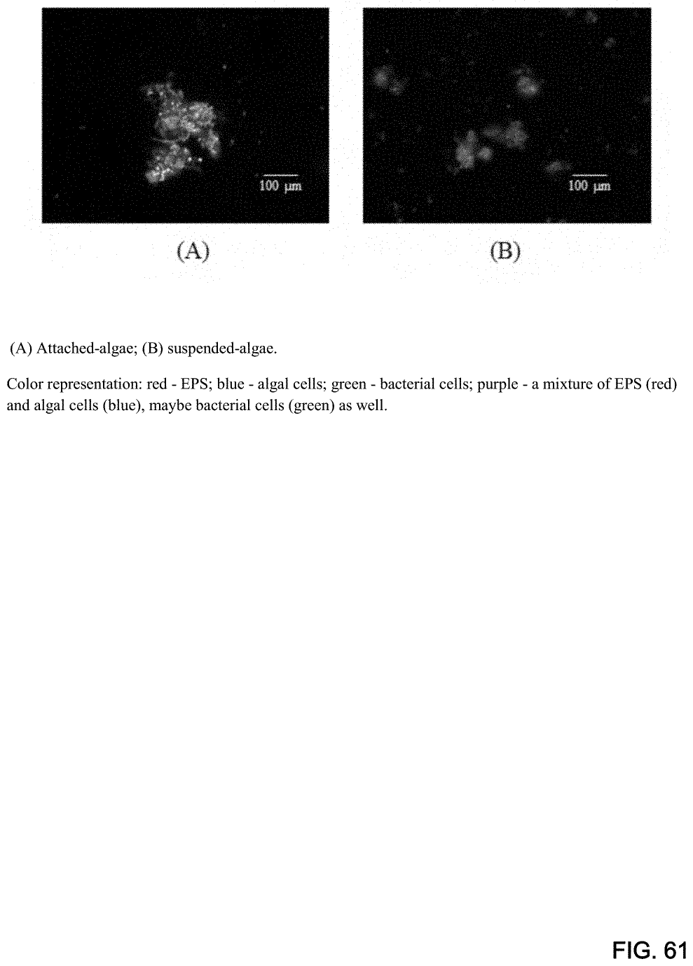

As provided above, the system 10 may utilize any type of algae 52 without departing from the scope of the disclosure. However, there are many advantages to utilizing biofilm algae 56. For example, as illustrated in FIG. 60, the content of EPS in biofilm algae 56 is greater than the EPS content in suspended algae. Since EPS protects the algae from toxic effects of high concentrations of minerals 58 there is a significant advantage to utilizing biofilm algae 56. Also, it should be noted, in reference to FIG. 60, no sterilization is applied to the algae cultures. As a result, bacterial cells may exist in each culture (i.e., the attached algae culture and the suspended algae culture) which may contribute to EPS secretion and increase the EPS content as illustrated in FIG. 61. For clarification, FIG. 61 provides confocal laser-scanning microscopy (CLSM) images of algal biomasses. FIG. 61(A) provides a CLSM image of attached algae or biofilm algae 56 and FIG. 61(B) provides a CLSM image of suspended algae. The CLSM images provide a visual representation of the different elements contained within the biomasses. In FIG. 61 the matter depicted in red is EPS, the matter depicted in blue are the algal cells, the matter depicted in green are the bacterial cells, the matter depicted in purple is a mixture of EPS (red), algal cells (blue), and perhaps bacterial cells (green).

Algae Slurry

The system 10 is capable of producing a mineral-rich algae 62. In one embodiment, as indicated above, the system 10 is capable of producing a mineral-rich algae 62 by growing algae 52, harvesting the algae 52 and adding a mineral-rich fluid 60 to the algae to produce an algae slurry 102, and allowing the algae 52 to absorb minerals 58 contained within the mineral-rich fluid 60 thereby growing a mineral-rich algae 62. The algae slurry 102 is comprised of attached algae 56, suspended algae, and fluid, among other components. Any species or type of algae 52 may be utilized in the algae slurry 102 without departing from the disclosure. In one arrangement, as one example, the algae slurry 102 may contain Chlorella algae 88 or Spirulina algae 90. Additionally, in one arrangement, the algae slurry 102 may comprise algae 52 of the type regarded as Generally Regarded as Safe 86.

Minerals

The system 10 provides a method of producing a mineral-rich algae 62. Any type of mineral 58 or vitamin is contemplated without departing from the scope of the disclosure. Any reference to mineral 58 throughout the disclosure shall be interpreted to refer to any type of mineral 58 or vitamin unless specifically identified. In one arrangement, as one example, the mineral 58 is selenium 96, calcium, or iron.

Furthermore, as indicated throughout the disclosure, the system 10 may utilize a mineral-rich fluid or feedstock 60 in order to supplement the algae 52 and produce mineral-rich algae 62. In one embodiment, the mineral-rich fluid or feedstock 60 is comprised of one mineral 58 or vitamin. While in an alternative embodiment, the mineral-rich fluid or feedstock 60 is comprised of a collection of minerals 58 or vitamins.

In one embodiment, the system 10 comprises the steps of: growing algae 52 in a reservoir 24, harvesting the algae 52, moving the algae 52 to a second reservoir 24 wherein a mineral-rich fluid 60 is added to the algae 52 to produce an algae slurry 102, allowing the algae 52 to absorb and adsorb minerals 58 contained within the mineral-rich fluid 60 thereby growing a mineral-rich algae 62. In another embodiment, the system 10 comprises the steps of: providing an algae biofilm growing apparatus 12, growing algae 52 using the algae biofilm growing apparatus 12, feeding the algae 52 a selenium-rich feed stock 92 thereby growing a selenium-rich algae 94.

Any type of selenium-rich feed stock 92 is contemplated for use without departing from the scope of the disclosure. In one arrangement, as one example, the selenium-rich feedstock 92 is an inorganic selenium 64. In one arrangement, as one example, the selenium-rich feedstock 92 is an inorganic selenium 64, wherein the algae 52 absorbs the inorganic selenium-rich feedstock 92 thereby producing a bio-available selenium 72. In an alternative arrangement, as one example, the selenium-rich feedstock 92 is an inorganic selenium 64, wherein the algae 52 absorbs the inorganic selenium-rich feedstock 92 on the algae cell's surface 54 thereby producing a bio-available selenium 72. However, in another arrangement, the selenium-rich feed stock 92 is an organic selenium

In another arrangement, as one example, the selenium-rich feedstock 92 includes a selenium salt 66. Additionally, in one arrangement, the selenium-rich feedstock 92 includes sodium selenite 68 or sodium selenate 70. Another form of selenium 96 or method of feeding selenium 96 to algae 52 is hereby contemplated for use.

Algae Biofilm Growing Apparatus

As provided above, system 10 may utilize an algae biofilm growing apparatus 12. Algae biofilm growing apparatus 12 is formed of any suitable size, shape, and design and is configured to grow algae 52. The algae biofilm growing apparatus 12 is configured to grow algae 52 in any form without departing from the scope of the disclosure. In one arrangement, as one example, the algae biofilm growing apparatus 12 is configured to grow algae 52 in a biofilm 56. In one arrangement, as one example, the algae biofilm growing apparatus 12 is configured to grow algae 52 in a biofilm 56 wherein the algae biofilm 56 is grown on the at least one moving belt 36. In the arrangement shown, as one example, for purposes of clarity, the algae biofilm growing apparatus 12 has a top 14, a bottom 16, and opposing sides 18. In the arrangement shown, as one example, the algae biofilm growing apparatus 12 is symmetrical, or generally symmetrical, or operatively symmetrical, and for this reason, unless specified otherwise, description of one side 18 of the algae biofilm growing apparatus 12 shall apply to both sides 18 of the algae biofilm growing apparatus 12 which is separated by an imaginary centerline that extends down the approximate top-to-bottom center of the algae biofilm growing apparatus 12. Further description of an algae biofilm growing apparatus can be found in U.S. Pat. No. 9,932,549, which is hereby incorporated by reference in its entirety.

In the arrangement shown, as one example, the algae biofilm apparatus 12 is formed of a frame 22, a reservoir 24, at least one drive shaft 28, a gear system 30, a plurality of rollers 32, a mechanized harvesting system 34 which comprises at least one moving belt 36, a harvesting blade 38, a harvesting reservoir, a fluid 42, a CO₂-rich gaseous phase 48 (also referred to as “air” throughout the disclosure), and light 50 (also referred to as a “sunlight capture” part throughout the disclosure). Furthermore, the algae biofilm growing apparatus 12 may also include additional components, such as, a pump 20. Any type or form of algae biofilm growing apparatus 12 may be utilized in the system 10, including, but not limited to, horizontal stationary sheets with algae growing on the surface, vertical stationary sheets with biofilm growing on the surface, rotating drums with algae growing on the surface, small floating beads and/or solid media with algae growing on their surface without departing from the scope of the disclosure.

Frame

As provided above, the algae biofilm growing apparatus 12 comprises a frame 22, among other components. Frame 22 is formed of any suitable size, shape, and design and is configured to support the algae biofilm growing apparatus 12 and allow the algae biofilm growing apparatus 12 to remain in an upright position in order to operate. In one arrangement, frame is square or rectangular in shape. However, any other shape or configuration is hereby contemplated for use. The frame 22 may be configured to be any size without departing from the disclosure. The frame 22 may be manufactured to be small enough to fit on a shelf for research purposes and the like or large enough to serve a large metropolitan city. Furthermore, frame 22 may be formed of any material including, but not limited to, plastic, metal, non-metal material, and PVC.

Frame 22 provides the structure of the algae biofilm growing apparatus 12. In one arrangement, as shown, the at least one moving belt 36 is supported by frame 22. In one arrangement, the at least one drive shaft 28 is coupled with the frame 22 wherein the at least one drive shaft 28 supports and actuates the at least one moving belt 36. In one arrangement, as one example, algae biofilm growing apparatus 12 comprises a gear system 30 wherein the gear system 30 is coupled with the at least one drive shaft 28, a plurality of rollers 32 wherein the plurality of rollers 32 is coupled with the frame 22 which guides the at least one moving belt 36.

Reservoir

As stated above, the algae biofilm growing apparatus 12 comprises a reservoir 24, among other components. Reservoir 24 is formed of any suitable size, shape, and design and is configured to support the algae biofilm growing apparatus 12 and contain a fluid 42. In one arrangement, as one example, reservoir 24 is circular, square, or rectangular in shape. However, any other shape or configuration is hereby contemplated for use. Furthermore, the reservoir 24, and the algae biofilm growing apparatus 12, may be any size without departing from the disclosure. The reservoir 24, and the algae biofilm growing apparatus 12, may be manufactured to be small enough to fit on a shelf for research purposes and the like, or large enough to efficiently and effectively serve a large metropolitan city. Reservoir 24 may be formed of any type of reservoir 24 configured to contain fluid 42 including, but not limited to, a trough system 100.

In one arrangement, as shown, reservoir 24 is located at the bottom 22 of the algae biofilm growing apparatus 12. The reservoir 24 is designed to contain or hold the fluid 42. In one arrangement, as one example, the at least one moving belt 36 is moved through the algae biofilm growing apparatus 12 wherein a portion of the at least one moving belt 36 is in a submerged position 44 wherein the at least one moving belt 36 is submerged within the fluid 42 held within the reservoir 24, and then to an exposed position 46 wherein a portion of the at least one moving belt 36 is not submerged within the fluid 42 held within the reservoir 24, but is exposed to air 48 and light 50.

In one arrangement, as one example, reservoir 24 may also include a pump 20 which is configured to circulate fluid 42 within reservoir 24. The circulation of the fluid 42 within reservoir 24 may improve the growth of algae 52 and the efficiency of the system 10. As described in more detail below, pump 20 may be any type of pump 20 such as a paddlewheel 98.

Motor

Motor 26 is formed of any suitable size, shape, and design. Motor 26 is any form of a motor that converts electrical energy to mechanical energy and provides rotation and torque. In one arrangement, as one example, the motor 26 can include a gear system 30 that is capable of driving the at least one drive shaft 28 wherein the at least one drive shaft 28 rotates the at least one moving belt 36. The rotating of the at least one moving belt 36 allows the at least one moving belt 36 to be in a submerged position 44 wherein a portion of the at least one moving belt 36 is submerged within the fluid 42 held within the reservoir 24, and an exposed position 46 wherein a portion of the at least one moving belt 36 is not submerged within the fluid 42 held within the reservoir 24.

Drive Shaft

The algae biofilm growing apparatus 12 comprises at least one drive shaft 28 which is formed of any suitable size, shape, and design. In one arrangement, as one example, the at least one drive shaft 28 extends from one side 18 of the algae biofilm growing apparatus 12 to the opposing side 18 wherein the at least one moving belt 36 is placed over the at least one drive shaft 28 allowing for the at least one drive shaft 28 to rotate and move the at least one moving belt 36 causing the at least one moving belt 36 to move between a submerged position 44 wherein a portion of the at least one moving belt 36 is submerged within the fluid 42 held within the reservoir 24, and an exposed position 46 wherein a portion of the at least one moving belt 36 is not submerged within the fluid 42 held within the reservoir 24.

Gear System

The algae biofilm growing apparatus 12 comprises a gear system 30, in addition to other components. In one arrangement, as one example, the gear system 30 may be a plurality of gear systems 30. Any number of gear systems 30 may be used without departing from the scope of the disclosure. For example, the algae biofilm growing apparatus 12 may comprise one, two, three, four, five, six, seven, eight, nine, ten, or more gear systems 30 without departing from the scope of the disclosure. Furthermore, the gear system 30 is formed of any suitable size, shape, and design.

The gear system 30 may be comprised of any form of a gear system 30 including, but not limited to, a pulley system, that is configured to direct power to the algae biofilm growing apparatus 12. The gear system 30 is configured to drive the at least one drive shaft 28 wherein the at least one drive shaft 28 rotates the at least one moving belt 36. The rotating of the at least one moving belt 36 allows the at least one moving belt 36 to be in a submerged position 44 wherein a portion of the at least one moving belt 36 is submerged within the fluid 42 held within the reservoir 24, and an exposed position 46 wherein a portion of the at least one moving belt 36 is not submerged within the fluid 42 held within the reservoir 24.

Rollers

The algae biofilm growing apparatus 12 may comprise, in addition to other components, a plurality of rollers 32. The plurality of rollers 32 is formed of any suitable size, shape, and design. In one arrangement, as one example, the plurality of rollers 32 are cylindrical in shape. However, any other shape or configuration is hereby contemplated for use. Additionally, in one arrangement, as an example, one, two, three, four, five, or more rollers 32 may be used. Any number of rollers 32 may be used without departing from the scope of the disclosure.

The plurality of rollers 32 is formed of any suitable size, shape, and design and is configured to provide guidance, direction, and support to the at least one moving belt 32 as the at least one moving belt 36 moves through the algae biofilm growing apparatus 12.

Pump

The algae biofilm growing apparatus 12 may comprise, in addition to other components, a pump 20. The pump 20 is formed of any suitable size, shape, and design. Pump 20 may be formed of any size without departing from the disclosure.

Pump 20 is configured to circulate fluid 42 within the reservoir 24 which may improve the growth of algae 52 and the efficiency of the system 10. Pump 20 can be any type of pump including, but not limited to, an electric pump, a wheel, a paddlewheel 98 or any other type of pump 20 that is configured to circulate fluid 42.

Mechanized Harvesting System

As stated above, the system 10 may comprise the step of harvesting the algae 52. The process of harvesting the algae 52 may be conducted by any means or tool without departing from the scope of the disclosure. In one arrangement, the process of harvesting the algae 52 may be conducted by a mechanical means. Therefore, the algae biofilm growing apparatus 12 may comprise, in addition to other components, a mechanized harvesting system 34. The mechanized harvesting system 34 is formed of any suitable size, shape, and design. The mechanized harvesting system 34 comprises at least one moving belt 36, a harvesting blade 38, and a harvesting reservoir 40. The mechanized harvesting system 34 may be triangular in shape in order to efficiently move the at least one belt 36 through the algae biofilm growing apparatus 12 wherein the at least moving belt 36 is transitioned between a submerged position 44, wherein a portion of the at least one moving belt 36 is submerged within the fluid 42 held within the reservoir 24, and an exposed position 46, wherein a portion of the at least one moving belt 36 is not submerged within the fluid 42 held within the reservoir 24. As a result, the portion of the at least one moving belt 36 that is not submerged within the fluid 42 held within the reservoir 24 is exposed to air (a CO₂-rich gaseous phase) 48 and light 50 (a “sunlight capture” part of the system 10).

Belt

As provided above, the algae biofilm growing apparatus 12 may comprise, among other components, a mechanized harvesting system 34. The mechanized harvesting system 34 comprises at least one moving belt 36, among other components. The at least one moving belt 36 is formed of any suitable size, shape, and design. The at least one moving belt 36 may be formed of any material without departing from the scope of the disclosure. The at least one belt 36 may be formed of any type of material, including, but not limited to, plastic, metal, non-metal materials, rubber, polyvinyl chloride (PVC), or any other type of material.

In one arrangement, as one example, the at least one belt 36 is controlled by the motor 26, the gear system 30 and the at least one drive shaft 28 wherein the at least one drive shaft 28 rotates the at least one moving belt 36. The rotation of the at least one moving belt 36 allows the at least one moving belt 36 to move to a submerged position 44 wherein a portion of the at least one moving belt 36 is submerged within the fluid 42 held within the reservoir 24, and then to an exposed position 46 wherein a portion of the at least one moving belt 36 is not submerged within the fluid 42 held within the reservoir 24.

The at least one moving belt 36 may move through the algae biofilm growing apparatus 12 in any type of configuration or movement without departing from the scope of the disclosure. In one arrangement, as one example, the at least one belt 36 moves through the algae biofilm growing apparatus 12 in a continuous manner or loop between the submerged position 44 and the exposed position 46. In an alternative arrangement, the at least one belt 36 moves in a serpentine manner between the submerged position 44 and the exposed position 46. Furthermore, the at least one moving belt 36 may move through the algae biofilm growing apparatus 12 in any direction or configuration, including, but not limited to, horizontal, vertical, downward, upward, etc. without departing from the scope of the disclosure. In one arrangement, as shown, the at least one moving belt 36 moves through the algae biofilm growing apparatus 12 in a substantially vertical configuration.

Harvesting Blade

As the at least one moving belt 36 moves through the algae biofilm growing apparatus 12, algae 52 grows in a biofilm 56 which forms on the at least one moving belt 36. The algae 52 that is produced must be harvested or removed from the at least one moving belt 36. One method of harvesting the algae 80 that is produced is to scrape the algae 52 off of the at least one moving belt 36. In one arrangement, the system 10 comprises the step of harvesting the mineral-rich or selenium-rich algae 80 by positioning a harvesting blade 38 along the at least one moving belt 36 in order to scrape the algae 52 off of the at least one moving belt 36. Therefore, the mechanized harvesting system 34 comprises a harvesting blade 38.

The harvesting blade 38 is formed of any suitable size, shape, and design. The harvesting blade 38 may be formed of any material that is suitable for harvesting or removing algae from the at least one moving belt 36, such as a squeegee, a piece of plastic, a piece of rubber, a piece of metal, or the like. The harvesting blade 38 may be formed of any material without departing from the scope of the disclosure.

Harvesting Reservoir

As stated above, the algae biofilm growing apparatus 12 may comprise, in addition to other components, a mechanized harvesting system 34. The mechanized harvesting system 34 may comprise, among other components, a harvesting reservoir 40. The harvesting reservoir 40 may be formed of any suitable size, shape, and design. Furthermore, the harvesting reservoir 40 may be formed of any material that is suitable for accepting and storing algae 52. The harvesting reservoir 40 may be formed of any material without departing from the scope of the disclosure. The harvesting reservoir 40 may be connected to the harvesting blade 38 or positioned next to the harvesting blade 38 and is configured to receive the algae 52 as the algae 52 is harvested from the at least one moving belt 36.

Fluid

As stated above, the algae biofilm growing apparatus 12 comprises a fluid 42, among other components. The fluid 42 may be any type of fluid 42, including, but not limited to, water, wastewater, effluent, and the like. In one arrangement, as one example, the fluid 42 is effluent from a feed manufacturer which contains a high concentration of selenium or any other mineral. In another arrangement, as one example, the fluid 42 is water wherein minerals such as selenium are added to the fluid 42.

In one arrangement, as one example, the motor 26 includes a gear system 30 that is capable of driving the at least one drive shaft 28 wherein the at least one drive shaft 28 rotates the at least one moving belt 36. The rotation of the at least one moving belt 36 allows the at least one moving belt 36 to be in a submerged position 44 wherein a portion of the at least one moving belt 36 is submerged within the fluid 42 held within the reservoir 24. In one arrangement, as one example, algae 52 is produced as the at least one moving belt 36 moves through the algae biofilm growing apparatus 12.

In one arrangement, as one example, a mineral 58, such as Selenium 96, and the like, is added to the fluid 42 wherein the algae 52, as it is produced or grown using the algae biofilm growing apparatus 12, absorbs and/or adsorbs the mineral 58 from the fluid 42 thereby producing a mineral-rich algae 62. Alternatively, in another arrangement, a mineral 58, such as Selenium 96, or the like, is already present in the fluid 42. For example, the fluid 42 may be wastewater or effluent which already contains a mineral 58. In this arrangement, the method of producing a mineral-rich algae 62 will be used to grow algae 52 using the algae biofilm growing apparatus 12 and feeding the algae 52 a mineral-rich feedstock 60 thereby growing a mineral-rich algae 62.

In Operation

In one arrangement, as one example, the system 10 comprises the steps of: providing an algae biofilm growing apparatus 12, growing algae 52 using the algae biofilm growing apparatus 12, feeding the algae 52 a mineral-rich feedstock 60 thereby growing a mineral-rich algae 62. The mineral-rich feedstock 60 may be comprised of any type of mineral 58 and the minerals 58. In one arrangement, the minerals 58 may be an inorganic mineral 58 wherein the algae 52 absorbs the inorganic mineral 58 and produces a bio-available mineral 58. In another embodiment, the minerals 58 may be organic minerals 58 wherein the algae 52 absorbs the organic minerals 58 and produces bio-available minerals 58. Furthermore, in one arrangement, the mineral-rich feedstock 60 may be inorganic minerals 58 wherein the algae adsorbs the mineral-rich feedstock on the algae cells surface thereby producing bio-available minerals 58/72. In one arrangement, as an example, the algae biofilm growing apparatus 12 is exposed to air 48, which is rich in carbon dioxide, wherein the temperature of the air 48 within the algae biofilm growing apparatus 12 is controlled 76 in order to facilitate the production of algae 52. Furthermore, in one arrangement, the algae biofilm growing apparatus 12 is exposed to light 50 wherein the light 50 within the algae biofilm growing apparatus 12 is controlled 78 in order to facilitate the production of algae 52. In another arrangement, the system 10 comprises the step of harvesting the mineral-rich algae 80 and using the harvested mineral-rich algae as a foodstuff for human and animal consumption 82/84.

In one example, the system 10 comprises the steps of: providing an algae biofilm growing apparatus 12, growing algae 52 using the algae biofilm growing apparatus 12, feeding the algae 52 a selenium-rich feedstock 92 thereby growing a selenium-rich algae 94. The selenium-rich feedstock 92 may comprise of inorganic selenium 64, a selenium salt 66, sodium selenite 68, and/or sodium selenate 70. In one arrangement, the system 10 further comprises the selenium-rich feedstock 92 being comprised of an inorganic selenium 64 wherein the algae 52 absorbs the inorganic selenium-rich feedstock 92 thereby producing a bio-available selenium 72. Furthermore, in one arrangement, as one example, the system 10 comprises the algae 52 containing extracellular polymeric substances 74 which enhance adsorption of selenium 96 by the algae 52. In one arrangement, as an example, the algae biofilm growing apparatus 12 is exposed to air 48, which is rich in carbon dioxide, wherein the temperature of the air 48 within the algae biofilm growing apparatus 12 is controlled 76 in order to facilitate the production of algae 52. Furthermore, in one arrangement, the algae biofilm growing apparatus 12 is exposed to light 50 wherein the light 50 within the algae biofilm growing apparatus 12 is controlled 78 in order to facilitate the production of algae 52. In another arrangement, the system 10 comprises the step of harvesting the selenium-rich algae 80 and using the harvested selenium-rich algae as a foodstuff for human and animal consumption 82/84.

Additionally, in one arrangement, as an example, the system 10 comprises the steps of: providing an algae biofilm growing apparatus 12 having a reservoir 24 filled with fluid 42 and at least one moving belt 36; moving the at least one belt 36 between a submerged position 44, wherein a portion of the at least one belt 36 is submerged within the fluid 42 held within the reservoir 24, and an exposed position 46, wherein a portion of the at least one belt 36 is not submerged within the fluid 42 held within the reservoir 24; exposing the portion of the at least one belt 36 in the exposed position 46 to air 48 and light 50; growing algae 52 as an algae biofilm 56 as the at least one moving belt 36 moves through the algae biofilm growing apparatus 12; and feeding the algae 52 a mineral-rich feed stock 60 thereby growing a mineral rich algae 62. The mineral-rich feedstock 60 may be comprised of any type of mineral 58 and the minerals 58. In one arrangement, the minerals 58 may be an inorganic mineral 58 wherein the algae 52 absorbs the inorganic mineral 58 and produces a bio-available mineral 58. In one arrangement, as an example, the algae biofilm growing apparatus 12 is exposed to air 48, which is rich in carbon dioxide, wherein the temperature of the air 48 within the algae biofilm growing apparatus 12 is controlled 76 in order to facilitate the production of algae 52. Furthermore, in one arrangement, the algae biofilm growing apparatus 12 is exposed to light 50 wherein the light 50 within the algae biofilm growing apparatus 12 is controlled 78 in order to facilitate the production of algae 52. In another arrangement, the system 10 comprises the step of harvesting the mineral-rich algae 80 and using the harvested mineral-rich algae as a foodstuff for human and animal consumption 82/84.

Furthermore, in one arrangement, as one example, the system comprises the steps of: providing an algae biofilm growing apparatus 12 having a reservoir 24 filled with fluid 42 and at least one moving belt 36; moving the at least one belt 36 between a submerged position 44, wherein a portion of the at least one belt 36 is submerged within the fluid 42 held within the reservoir 24, and an exposed position 46, wherein a portion of the at least one belt 36 is not submerged within the fluid 42 held within the reservoir 24; exposing the portion of the at least one belt 36 in the exposed position 46 to air 48 and light 50; growing algae 52 as an algae biofilm 56 as the at least one moving belt 36 moves through the algae biofilm growing apparatus 12; and feeding the algae 52 a selenium-rich feed stock 92 thereby growing a selenium-rich algae 94. The selenium-rich feedstock 92 may comprise of inorganic selenium 64, a selenium salt 66, sodium selenite 68, and/or sodium selenate 70. In one arrangement, the system 10 further comprises the selenium-rich feedstock 92 being comprised of an inorganic selenium 64 wherein the algae 52 absorbs the inorganic selenium-rich feedstock 92 thereby producing a bio-available selenium 72. Furthermore, in one arrangement, as one example, the system 10 comprises the algae 52 containing extracellular polymeric substances 74 which enhance absorption of selenium 96 by the algae 52. In one arrangement, as an example, the algae biofilm growing apparatus 12 is exposed to air 48, which is rich in carbon dioxide, wherein the temperature of the air 48 within the algae biofilm growing apparatus 12 is controlled 76 in order to facilitate the production of algae 52. Furthermore, in one arrangement, the algae biofilm growing apparatus 12 is exposed to light 50 wherein the light 50 within the algae biofilm growing apparatus 12 is controlled 78 in order to facilitate the production of algae 52. In another arrangement, the system 10 comprises the step of harvesting the selenium-rich algae 80 and using the harvested selenium-rich algae as a foodstuff for human and animal consumption 82/84.

In an alternative embodiment, the system 10 comprises the steps of: growing algae 52 in a reservoir 24, harvesting the algae 52, moving the algae 52 to a second reservoir 24 wherein a mineral-rich fluid 60 is added to the algae 52 to produce an algae slurry 102, allowing the algae 52 to absorb minerals 58 contained within the mineral-rich fluid 60 thereby growing a mineral-rich algae 62. Furthermore, the mineral-rich feedstock 60 may comprise one mineral 58, one vitamin 58, a collection of minerals 58, a collection of vitamins 58, or a collection of minerals 58 and vitamins 58 without departing from the disclosure.

Additionally, in an alternative embodiment, the system 10 comprises the steps of: growing algae 52 in a reservoir 24, harvesting the algae 52, moving the algae 52 to a second reservoir 24 wherein a selenium-rich fluid 92 is added to the algae 52 to produce an algae slurry 102, allowing the algae 52 to absorb selenium 96 contained within the selenium-rich fluid 92 thereby growing a selenium-rich algae 94. In one embodiment, the selenium-rich fluid 92 is an inorganic selenium 64, wherein the algae 52 absorbs the inorganic selenium-rich fluid 92 thereby producing a bio-available selenium 72. In another embodiment, the selenium-rich fluid 92 is an inorganic selenium 64 wherein the algae 52 adsorbs the inorganic selenium-rich fluid 92 on the algae cells surface 54 thereby producing a bio-available selenium 72. Alternatively, in one embodiment, the selenium-rich fluid 92 is an organic selenium 96 wherein the algae 52 absorbs the organic selenium-rich fluid 92 thereby producing a bio-available selenium 72. In another embodiment, the selenium-rich fluid 92 is an organic selenium 96 wherein the algae 52 adsorbs the organic selenium-rich fluid 92 on the algae cells surface 54 thereby producing a bio-available selenium 72.

Benefits of System

The system 10 has many benefits and advantages including, but not limited to, providing a method of producing mineral-rich algae 62 that is easy to use; providing a method of producing mineral-rich algae 62 that is efficient; providing a method of producing mineral-rich algae 62 that is simple in design; providing a method of producing mineral-rich algae 62 that is inexpensive; providing a method of producing mineral-rich algae 62 that may be utilized as a foodstuff for human consumption 82; providing a method of producing mineral-rich algae 62 that may be utilized as a foodstuff for animal consumption 84; providing a method of producing mineral-rich algae 62 that optimizes mineral 58 accumulation in algae 52; providing a method of producing mineral-rich algae 62 that efficiently and effectively removes minerals 58 from fluid 42; providing a method of producing mineral-rich algae 62 that efficiently and effectively removes minerals 58 from effluent; and providing a method of producing mineral-rich algae 62 that provides for the algae 52 to absorb and/or adsorb inorganic minerals 58 and produce a bio-available mineral 58. These and other benefits and advantages of the system 10 are apparent from the specification and claims.

What is claimed:

1. A method of producing a selenium-rich algae, the steps comprising:
providing an algae biofilm growing apparatus;
growing algae using the algae biofilm growing apparatus;
feeding the algae a selenium-rich feedstock thereby growing a selenium-rich algae;
harvesting the selenium-rich algae.

2. The method of claim 1 wherein the selenium-rich feedstock is an inorganic selenium.

3. The method of claim 1 wherein the selenium-rich feedstock is an organic selenium.

4. The method of claim 1 wherein the selenium-rich feedstock includes a selenium salt.

5. The method of claim 1 wherein the selenium-rich feedstock includes sodium selenite.

6. The method of claim 1 wherein the selenium-rich feedstock includes sodium selenate.

7. The method of claim 1 wherein the algae absorbs the selenium-rich feedstock thereby producing a bio-available selenium.

8. The method of claim 1 wherein the algae adsorbs the selenium-rich feedstock on the algae cells' surface thereby producing a bio-available selenium.

9. The method of claim 1 wherein the algae absorbs and adsorbs the selenium-rich feedstock thereby producing a bio-available selenium.

10. The method of claim 1 wherein the algae contains extracellular polymeric substances which enhance adsorption of selenium by the algae.

11. The method of claim 1 wherein the algae contains extracellular polymeric substances which protect the algae from toxic effects of high concentrations of selenium.

12. The method of claim 1 wherein the algae biofilm growing apparatus is exposed to air, wherein the temperature of the air within the algae biofilm apparatus is controlled.

13. The method of claim 1 wherein the algae biofilm growing apparatus is exposed to light, wherein the light within the algae biofilm growing apparatus is controlled.

14. The method of claim 1 wherein the selenium-rich algae is mechanically harvested.

15. The method of claim 1, further comprising using the harvested selenium-rich algae as a foodstuff for human consumption.

16. The method of claim 1, further comprising using the harvested selenium-rich algae as a foodstuff for non-human animal consumption.

17. The method of claim 1 wherein the algae is of the type regarded as Generally Regarded As Safe.

18. The method of claim 1 wherein the algae is Chlorella algae.

19. The method of claim 1 wherein the algae is Spirulina algae.

20. The method of claim 1 wherein the algae is more than one species of algae.

21. A method of producing a mineral-rich algae, the steps comprising:
providing an algae biofilm growing apparatus;
growing algae using the algae biofilm growing apparatus;
feeding the algae a mineral-rich feedstock thereby growing a mineral-rich algae;
harvesting the mineral-rich algae.

22. The method of claim 21 wherein the mineral-rich feedstock is comprised of one mineral, one vitamin, a collection of minerals, a collection of vitamins, or a collection of minerals and vitamins.

23. A method of producing a selenium-rich algae, the steps comprising:
providing an algae biofilm growing apparatus having a reservoir filled with fluid and at least one moving belt;
moving the at least one belt between a submerged position, wherein a portion of the at least one belt is submerged within the fluid held within the reservoir, and an exposed position, wherein a portion of the at least one belt is not submerged within the fluid held within the reservoir;
exposing the portion of the at least one belt in the exposed position to air and light;
growing algae on a biofilm as the at least one belt moves through the algae biofilm growing apparatus;
feeding the algae a selenium-rich feedstock thereby growing a selenium-rich algae.

24. The method of claim 23 wherein the selenium-rich feedstock is an inorganic selenium.

25. The method of claim 23 wherein the selenium-rich feedstock is an organic selenium.

26. The method of claim 23 wherein the selenium-rich feedstock includes a selenium salt.

27. The method of claim 23 wherein the selenium-rich feedstock includes sodium selenite.

28. The method of claim 23 wherein the selenium-rich feedstock includes sodium selenate.

29. The method of claim 23 wherein the algae absorbs the selenium-rich feedstock thereby producing a bio-available selenium.

30. The method of claim 23 wherein the algae adsorbs the selenium-rich feedstock on the algae cells' surface thereby producing a bio-available selenium.

31. The method of claim 23 wherein the algae absorbs and adsorbs the selenium-rich feedstock thereby producing a bio-available selenium.

32. The method of claim 23 wherein the algae contains extracellular polymeric substances which enhance adsorption of selenium by the algae.

33. The method of claim 23 wherein the algae contains extracellular polymeric substances which protect the algae from toxic effects of high concentrations of selenium in the fluid.

34. The method of claim 23 wherein the at least one belt moves in a continuous loop between the submerged position and the exposed position.

35. The method of claim 23 wherein the at least one belt moves in a serpentine manner between the submerged position and the exposed position.

36. The method of claim 23, further comprising controlling the temperature of the air within the algae biofilm growing apparatus.

37. The method of claim 23, further comprising controlling the temperature of the fluid within the reservoir.

38. The method of claim 23, further comprising controlling the light within the algae biofilm growing apparatus.

39. The method of claim 23 wherein the selenium-rich algae is mechanically harvested.

40. The method of claim 23 wherein the selenium-rich algae is harvested by scraping a blade along the at least one belt.

41. The method of claim 23, further comprising using the harvested selenium-rich algae as a foodstuff for human consumption.

42. The method of claim 23, further comprising using the harvested selenium-rich algae as a foodstuff for non-human animal consumption.

43. The method of claim 23 wherein the at least one belt moves on a plurality of rollers.

44. The method of claim 23 wherein the algae is of the type regarded as Generally Regarded As Safe.

45. The method of claim 23 wherein the algae is Chlorella algae.

46. The method of claim 23 wherein the algae is Spirulina algae.

47. The method of claim 23 wherein the algae is more than one species of algae.

48. A method of producing a mineral-rich algae, the steps comprising:
providing an algae biofilm growing apparatus having a reservoir filled with fluid and at least one moving belt;
moving the at least one belt between a submerged position, wherein a portion of the at least one belt is submerged within the fluid held within the reservoir, and an exposed position, wherein a portion of the at least one belt is not submerged within the fluid held within the reservoir;
exposing the portion of the at least one belt in the exposed position to air and light;
growing algae using a biofilm as the at least one belt moves through the algae biofilm growing apparatus;
feeding the algae a mineral-rich feedstock thereby growing a mineral-rich algae.

49. The method of claim 48 wherein the mineral-rich feedstock is comprised of one mineral, one vitamin, a collection of minerals, a collection of vitamins, or a collection of minerals and vitamins.

50. A method of producing a selenium-rich algae, the steps comprising:
growing algae;
harvesting the algae;
adding a selenium-rich fluid to the algae to produce an algae slurry;
allowing the algae to absorb selenium contained within the selenium-rich fluid thereby growing a selenium-rich algae.

51. The method of claim 50 wherein the algae absorbs the selenium-rich fluid thereby producing a bio-available selenium.

52. The method of claim 50 wherein the algae adsorbs the selenium-rich fluid on the algae cells' surface thereby producing a bio-available selenium.

53. The method of claim 50 wherein the algae absorbs and adsorbs the selenium-rich fluid thereby producing a bio-available selenium.

54. A method of producing a mineral-rich algae, the steps comprising:
growing algae;
harvesting the algae;
adding a mineral-rich fluid to the algae to produce an algae slurry;
allowing the algae to absorb minerals contained within the mineral-rich fluid thereby growing a mineral-rich algae.

55. The method of claim 54 wherein the mineral-rich feedstock is comprised of one mineral, one vitamin, a collection of minerals, a collection of vitamins, or a collection of minerals and vitamins.
